(19) United States
(12) Patent Application Publication
(10) Pub. No.: US 2021/0120811 A1
(43) Pub. Date: Apr. 29, 2021

(54) AQUEOUS CAPSULE SUSPENSION CONCENTRATES CONTAINING A HERBICIDAL SAFENER AND A PESTICIDAL ACTIVE SUBSTANCE

(71) Applicant: Bayer Aktiengesellschaft, Leverkusen (DE)

(72) Inventors: Jens KRAUSE, Leverkusen (DE); Steffen ZANTER, Wermelskirchen (DE); Arno RATSCHINSKI, Duesseldorf (DE); Thomas WILDE, Weilrod-Hasselbach (DE); Thomas AULER, Bergisch Gladbach (DE)

(21) Appl. No.: 17/051,926

(22) PCT Filed: Apr. 30, 2019
(86) PCT No.: PCT/EP2019/061009

§ 371 Date: Oct. 30, 2020

(30) Foreign Application Priority Data
May 3, 2018 (EP) 18170584.9

(51) Int. Cl. A01N 25/28; A01N 43/80; A01N 43/56; A01N 43/42; A01N 43/82; A01N 43/40; A01N 25/32

(52) U.S. Cl. CPC A01N 25/28; A01N 43/80; A01N 43/56; A01N 25/32; A01N 43/82; A01N 43/40; A01N 43/42

(57) ABSTRACT

The present invention relates to aqueous capsule suspension concentrates based on 2-[(2,4-dichlorophenyl)methyl]-4,4′-dimethyl-3-isoxazolidinone and mefenpyr-diethyl, to the production thereof and to mixtures thereof with suspension concentrates of further active ingredients, and to the use thereof as an agrochemical formulation.

The present invention relates to aqueous capsule suspension concentrates based on 2-[(2,4-dichlorophenyl)methyl]-4,4′-dimethyl-3-isoxazolidinone and mefenpyr-diethyl, to the production thereof and to mixtures thereof with suspension concentrates of further active ingredients, and to the use thereof as an agrochemical formulation.

Active ingredients can in principle be formulated in many different ways, and the properties of the active ingredients and the nature of the formulation can present problems in terms of producibility, stability, usability and efficacy of the formulations. Moreover, particular formulations are more advantageous than others for economic and environmental reasons.

Owing to their low and broad melting range and their amorphous structure, herbicide safeners are not easy to formulate. Products on the market consist of organic dispersions, emulsion concentrates, suspoemulsions, wherein the low-melting active ingredient is in dissolved or emulsified form. What is advantageous is the rapid bioavailability of the safener in dissolved form. What is disadvantageous is that these formulations cannot be mixed with aqueous formulations. What is also disadvantageous is that the safener is very rapidly bioavailable and in some cases is taken up too early in the plant, such that the protective effect can decline in the event of later uptake of the active ingredient. A new variant described as closest prior art is described in WO 2017/144497 A1. The safener here is added to water in liquid form, crystallized out and used in the form of a suspension concentrate (SC). The advantage of this SC is miscibility with other suspension concentrates. A disadvantage is miscibility with low-melting active ingredients in the suspension concentrates, which leads to agglomeration of the formulation. A further disadvantage with respect to the formulations in dissolved form is the lower initial bioavailability since the particle in the concentrate first has to be dissolved prior to uptake into the plant.

Herbicide safeners (for example mefenpyr-diethyl or cloquintocet-mexyl) are often in the form of esterified acids which are available in their technical grade quality as a solidified melt with a melting range, which rapidly leads to clumping with low-melting active ingredients in finished formulations.

For particular active ingredients, a safener is needed to avoid damage in the crop plant. A new active ingredient on the market is the active ingredient 2-[(2,4-dichlorophenyl)methyl]-4,4′-dimethyl-3-isoxazolidinone (CAS number 81777-95-9 or IUPAC 2-(2,4-dichlorobenzyl)-4,4-dimethyl-1,2-oxazolidin-3-one, abbreviated hereinafter to DCPMI). It is a chemical representative of clomazone (abbreviated hereinafter to CPMI, CAS 81777-89-1, IUPAC 2-(2-chlorobenzyl)-4,4-dimethyl-1,2-oxazolidin-3-one). By comparison with clomazone, DCPMI has much lower water solubility (39.5 ppm rather than 1000 ppm) and a somewhat lower vapor pressure (0.88 mPa compared to 19.2 mPa), and so the calculated Henry constant (distribution of the active ingredient through the water gas phase) is at a similar level. Both active ingredients belong to the class of the volatile active ingredients that can cause unwanted damage to neighboring crops. The low vapor pressure may also be associated with an unwanted broad distribution, which should be prevented for reasons of human and environmental toxicology and for economic reasons.

DCPMI is used in herbicidal compositions and mixtures or employed as a selective grass herbicide, as described, for example, in WO-A 2015/127259 or WO-A 2012/148689. The closest prior art may be considered to be WO 2018/024839 A1.

It was therefore an object of the present invention to provide a suitable encapsulation of low-melting active ingredients that is to lower the volatility by at least 70% (relative to unencapsulated active ingredient) and simultaneously brings about optimal release and action of the safener and assures a storage-stable formulation in combination with further active ingredients.

There is thus a need for novel formulations in the form of aqueous dispersions containing a low-melting herbicide safener having a melting temperature range that can be mixed with an active ingredient, preferably a low-melting active ingredient, without forming agglomerates and that have high, targeted bioavailability of the safener.

In addition, there is a need for formulations in which the safener has been encapsulated on its own without active ingredient in order to assure stable formulations in combination with low-melting active ingredient formulations.

It was thus an object of the present invention to provide aqueous formulations comprising a safener that does not form unwanted agglomerates.

It was thus an object of the present invention to provide aqueous formulations comprising safeners and further active ingredients z) without unwanted agglomerates in the formulations coupled with high efficacy of the safener, preferably with active ingredients b) likewise present in the capsule.

It has been found that, surprisingly, in the formulations of the invention, the safener s), in spite of the encapsulation, has good action, even though capsules are known to the person skilled in the art as slow-release formulations.

Suitable active ingredients z) and b) in the context of the present invention are all active agrochemical herbicidal ingredients that are soluble in a water-insoluble organic solvent.

Preferred active ingredients b) having a melting temperature range between 50 and 85° C. include: anilofos, acephate, benfluralin, bifenthrin, bupirimate, butralin, chloroacetic acid, cyfluthrin, cynmethylin, cypermethrin, demeton-S-methyl sulfone, dimethametryn, dimethoate, dioxabenzofos, diphenylamine, dithiopyr, dodemorph acetate, esfenvalerate, ethalfluralin, ethofumesate, fenazaquin, fenitropan, fenoxycarb, fenuron-TCA, fenvalerate, fluoroglycofen-ethyl, flupyradifuron, flurazole, flurochloridone, fluroxypyr-meptyl, flusilazole, furalaxyl, haloxyfop-etotyl, haloxyfop-methyl, imazalil, ioxynil octanoate, isoprothiolane, metalaxyl, methomyl, methoprotryne, monocrotophos, nitrapyrin, nitrothal-isopropyl, penconazole, pendimethalin, permethrin, propamocarb hydrochloride, propaquizafop, pyrazophos, quizalofop-P-tefuryl, resmethrin, trichloroacetic acid, tetramethrin, thiofanox, triflumizole, pyridaphenthion, 2-phenylphenol, dimethylvinphos, beta-cypermethrin, famphur, clodinafop-propargyl, triazamate, tebufenpyrad, pyrimidifen, aldrin, bromophos, dialifos, pyriminobac-methyl, benzoylprop, benzoylprop-ethyl, binapacryl, camphechlor, chlorfenethol, chlorfenprop, chlorfenprop-methyl, chlorphoxim, crufomate, cyometrinil, 1,1-dichloro-2,2-bis(4-ethylphenyl)ethane, dimetilan, dinobuton, fenson, fenthiaprop, fenthiaprop-ethyl, fluenetil, glyodin, 2-isovalerylindane-1,3-dione, methoxyphenone, 2-methoxyethylmercury chloride, nitrofen, indanofan, acequinocyl, ipsdienol with (S)-cis-verbenol, fenoxanil, pyraclostrobin, trifloxystrobin, cyflufenamid, gamma-cyhalothrin, proquinazid, 2,6-diisopropylnaphthalene, isotianil and 2-[(2,4-dichlorophenyl)methyl]-4,4′-dimethyl-3-isoxazolidinone.

Particular preference is given to b) 2-[(2,4-dichlorophenyl)methyl]-4,4′-dimethyl-3-isoxazolidinone (CAS number 81777-95-9 or IUPAC 2-(2,4-dichlorobenzyl)-4,4-dimethyl-1,2-oxazolidin-3-one, abbreviated hereinafter to DCPMI).

Formulations based on DCPMI are described in WO 2018/024839 and in WO 2015127259.

The formulations may optionally comprise further, nonencapsulated active ingredients z).

It was a further object of the present invention to incorporate the safener into the formulation in such a way that:
it does not form any agglomerates in a mixture with other active ingredients
the active ingredient b) or z), preferably DCPMI, has unchanged high activity
the volatility of the active ingredient b) or z) is not increased
the efficacy of the safener is unchanged and high.

The object was achieved by the capsule suspension concentrates (CS) of the invention that could be further formulated with further active ingredients to give ZC formulations. A ZC formulation is a mixture of a CS and a suspension concentrate (SC).

The present invention therefore provides capsule suspension concentrates comprising

A) a particulate disperse phase (capsule) comprising
a) a reaction product of at least one compound having isocyanate-reactive groups a1) and an isocyanate mixture a2),
b) optionally an active ingredient b)
s) a safener s), dissolved in an organic, water-insoluble solvent L),
c) optionally one or more additives and

B) d) a liquid aqueous phase,

wherein the particles of the disperse phase A) have a median particle size between 1 and 50 μm.

In a preferred embodiment, the CSs of the invention comprise at least one active ingredient b) in A).

In a preferred embodiment, the CSs of the invention comprise at least one or more than one additive c) in A).

Further preferably, the CSs of the invention comprise at least one protective colloid c1).

The particle size is determined according to CIPAC (CIPAC=Collaborative International Pesticides Analytical Council; www.cipac.org) Method MT 187 as d50 or D90=active ingredient particle size (laser scattering of 50% or 90% of all volume particles). The median particle size refers to the d50 value.

The particles of the disperse phase A) have a median particle size d50 which is generally between 1 and 50 μm, preferably 1 to 20 μm, most preferably between 3 and 15 μm.

The present invention likewise provides a process for producing the capsule suspension concentrates of the invention, characterized in that, in

step (1), a safener s) dissolved in an organic, water-insoluble solvent L) is mixed with the isocyanate mixture a2) and optionally with an organic solvent and/or emulsifier, the solution thus prepared is then, in

step (2), emulsified in water, optionally containing a protective colloid c1), optionally in a mixture with further additives d), and the emulsion E thus prepared, in

step (3), is admixed with isocyanate-reactive groups a1) and then, optionally, further additives d) are added.

In a preferred embodiment, in step 1, an active ingredient b) dissolved in an organic, water-insoluble solvent L) is further additionally added.

Preference is further given to using a protective colloid c1) in step 2.

The amounts stated hereinafter, unless described otherwise, relate to the total amount of A) and B).

In a further embodiment of the process of the invention, the emulsion E obtained in step 2, in step 3 of the process of the invention, can first be admixed with at least one diamine, polyamine, dialcohol, polyalcohol and/or amino alcohol a1) while stirring. The amine or alcohol components a1) are preferably added here in aqueous solution. After the reaction that leads to capsule formation has ended, additives c) are optionally added. Preference is given to using an amine as component a1) in the process of the invention.

For production of the CS of the invention, it is possible to use any apparatus customary for purposes of this kind that generates strong shear forces. Examples include rotor-stator mixers and jet dispersers.

In the performance of the process of the invention, the ratio of NCO groups from component a2) to NCO-reactive groups from component a1) may be varied within a particular range. In general, 0.8 to 1.5 equivalents of amine or alcohol component are used per 1 mol of isocyanate. Preferably, the amount of isocyanate and amine or alcohol is chosen such that equimolar amounts of isocyanate groups and of amino or hydroxyl groups are present.

In the performance of the process of the invention, the reaction temperatures can be varied within a particular range.

The first stage (1) of the process of the invention is generally conducted at temperatures between −10 and 80° C., preferably between 0° C. and 50° C., more preferably between 2° C. and 40° C., most preferably between 2° C. and 30° C., the second stage (2) generally at temperatures between −10° C. and +80° C., preferably between 0° C. and 80° C., and in the third stage (3) generally at temperatures between 0° C. and 80° C., preferably between 10° C. and 75° C.

The process of the invention is preferably performed under atmospheric pressure.

The wall thickness of the capsules of the capsule suspension concentrates of the invention is between 0.001 and 4 μm, preferably between 0.01 and 2 μm and most preferably between 0.01 and 1 μm (wall thickness calculated).

In the reaction of a1) with a2), the sum total of the number-average functionality X of isocyanate groups and isocyanate-reactive groups is 2≤X≤6, preferably 2≤X≤4.5, more preferably 2.0≤X≤3.5 and most preferably 2.2≤X≤2.8.

The “number-average functionality X” as feature in the process of the invention is illustrated as follows. It is the compound of higher functionality that is crucial here, and the result of subtracting 2 from the compound of lower functionality is added to the compound of higher functionality. If, for example, the (average) functionality of a1) is 2.1 and that of a2) is 2.6: 2.1-2=0.1. This difference is added to 2.6: 2.6+0.1=2.7.

The number-average functionality is thus 2.7. Alternatively, if a1) is 2.7 and a2) is 2.3, the number-average functionality is found to be 2.7+2.3−2=3.0.

The capsule suspension concentrates of the invention feature a number of advantages. For instance, they are capable of releasing the active components in the amount required in each case over a prolonged period. It is also favorable that the plant compatibility of the active ingredients present is improved, and volatility and hence damage to neighboring crops are reduced. Moreover, the acute toxicity of the active components is reduced, and so the deployment of the microcapsule formulations is unproblematic both to the operators and in respect of potentially phototoxic reactions.

Useful compounds having isocyanate-reactive groups a1) include aliphatic, aromatic, cyclic and alicyclic primary and secondary diamines, and also polyamines. Examples include ethylenediamine (1,2), diethylenetriamine, monoisopropylamine, 4-aminopyridine (4-AP), n-propylamine, ethylene- or propylenimine-based polyaziridine, triethylenetetraamine (TETA), tetraethylenepentamine, 2,4,4′-triaminodiphenyl ether, bis(hexamethylene)triamine, ethylenediamine (EDA), trimethylenedipiperidine (TMDP), guanidine carbonate (GUCA), phenylenediamine, toluenediamine, pentamethylenehexamine, 2,4-diamino-6-methyl-1,3,5-triazine, 1,2-diaminocyclohexane, 4,4′-diaminodiphenylmethane, 1,5-diaminonaphthalenisophoronediamine, diaminopropane, diaminobutane, piperazine, aminoethylenepiperazine (AEP), poly(propylene glycol) bis(2-aminopropyl ether) or o,o′-bis(2-aminopropyl)polypropylene glycol-block-polyethylene glycol-block-polypropylene glycol, hexamethylenediamine, bis(3-aminopropyl)amine, bis(2-methylaminoethyl)methylamine, 1,4-diaminocyclohexane, 3-amino-1-methylaminopropane, N-methylbis(3-aminopropyl)amine, 1,4-diamino-n-butane and 1,6-diamino-n-hexane. Preference is given to hexamethylenediamine and diethylenetriamine.

Useful compounds having isocyanate-reactive groups a1) likewise include primary and secondary, aliphatic and aromatic dialcohols and polyalcohols. Examples include: ethanediol, propanediol (1,2), propanediol (1,3), butanediol (1,4), pentanediol (1,5), hexanediol (1,6), glycerol and diethylene glycol. Preference is given to using glycerol and propane-1,2-diol.

Compounds having isocyanate-reactive group a1) also include amino alcohols. Examples include triethanolamine, monoethanolamine, triisopropanolamine, diisopropylamine, N-methylethanolamine, N-methyldiethanolamine.

In a very particularly preferred embodiment, an amine is used as isocyanate-reactive component a1).

The isocyanate mixture a2) is a mono-, di- and/or polyisocyanate mixture, or a reaction product of isocyanate mixtures. Suitable compound a2) are, for example, butylene 1,4-diisocyanate, hexamethylene 1,6-diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes (H12-MDT1 and mixtures thereof with any isomer content, cyclohexylene 1,4-diisocyanate, 4-isocyanatomethyloctane 1,8-diisocyanate (nonane triisocyanate), phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI), 1,3- and/or 1,4-bis(2-isocyanatoprop-2-yl)benzene (TMXDI), 1,3-bis(isocyanatomethyl)benzene (XDI), alkyl 2,6-diisocyanatohexanoates (lysine diisocyanates) having alkyl groups having 1 to 8 carbon atoms, and mixtures thereof. Compounds comprising modifications such as allophanate, uretdione, urethane, isocyanurate, biuret, iminooxadiazinedione or oxadiazinetrione structure and based on said diisocyanates are also suitable units for component a2), as also are polycyclic compounds, for example polymeric MDI (pMDI, for instance PAPI-27 from Dow or Desmodur® 44V20 products from Covestro AG) and combinations of the above.

Preference is given to modifications having an isocyanate (NCO) functionality of 2 to 6, preferably of 2.0 to 4.5 and more preferably of 2.3 to 4.2 and most preferably of 2.3 to 3.8. Especially preferred is an NCO functionality of 2.4 to 2.8.

Preference is given to modification using diisocyanates from the group of HDI, IPDI, H12-MDI, TDI and MDI. Particular preference is given to TDI and MDI, and derivatives thereof. Especially preferred MDI is polymeric MDI such as PAPI-27 used in a blend with TDI. The preferred NCO content of the isocyanate or polyisocyanate or blend is between 3% and 50% by weight, more preferably between 10% and 40% by weight, more preferably between 15% and 35% by weight and most preferably between 18% and 30% by weight. The isocyanate groups may also be present in partially or completely blocked form prior to their reaction with the isocyanate-reactive groups, in such a way that they cannot react immediately with the isocyanate-reactive group. This ensures that the reaction does not take place until a particular temperature (blocking temperature) has been reached. Typical blocking agents can be found in the prior art and are selected such that they are eliminated again from the isocyanate group at temperatures between 60 and 220° C., according to the substance, and only then react with the isocyanate-reactive group. There are blocking agents which become incorporated into the polyurethane, and there are also those which remain as solvents or plasticizers in the polyurethane, or are evolved as gases from the polyurethane. The expression “blocked NCO values” is sometimes used. When the expression “NCO values” is used in the invention, this always refers to the unblocked NCO value. The usual extent of blocking is up to <0.5%. Examples of typical blocking agents are caprolactam, methyl ethyl ketoxime, pyrazoles, for example 3,5-dimethyl-1,2-pyrazole or 1,-pyrazole, triazoles, for example 1,2,4-triazole, diisopropylamine, diethyl malonate, diethylamine, phenol and derivatives thereof, and imidazole.

Component a2) may also be used in the form of a mixture of the above compounds or else of a prepolymer. In this case, for example, a compound containing isocyanate groups and having an NCO content between 3% and 50% by weight is reacted with compounds containing toward isocyanate-reactive groups and having an OH number between 10 mg KOH/g and 150 mg KOH/g.

Very particular preference is given to using a mixture of polymeric (p)MDI and TD. The ratio of the pMDI to tolylene diisocyanate here may be varied within a particular ratio, preference being given to using 0.2% to 2% by weight of pMDI and 0.2% to 2% by weight of TDI.

The aqueous phase B) of the capsule suspension concentrates of the invention may, as well as water, also comprise further additives c) such as emulsifiers, protective colloids, preservatives, defoamers, cold stabilizers, thickeners, pH stabilizers and neutralizing agents. Preferred components c) are emulsifiers, thickeners and protective colloids c1).

Useful organic solvents L) include all customary organic solvents that on the one hand have low miscibility with water, but on the other hand dissolve the active agrochemical ingredients used with good solubility. Preferred examples include aliphatic and aromatic, optionally halogenated hydrocarbons such as toluene, xylene, Solvesso® 100, 100 ND, 150, 150 ND or 200,200 ND (mineral oil), tetrachloromethane, chloroform, methylene chloride and dichloroethane, and also esters such as ethyl acetate, and alkanecarboxamides such as N,N-dimethyloctanamide and N,N-dimethyldecanamide. In addition come vegetable oils and modified oil (for example by methylation, ethylation and also hydrogenation and hydration) based, for example, on rapeseed oil, corn kernel oil, coconut oil or the like. Particular preference is given to using mineral oil, very particular preference to using solvents based on a from dialkylnaphthalene (for example diisopropylnaphthalene), and mixture of 1-methyl- and 2-methylnaphthalene and naphthalene (for example Solvesso® 200 ND products, CAS No.: 64742-94-5).

Useful emulsifiers c) include standard surface-active substances present in formulations of active agrochemical ingredients. Examples include ethoxylated nonylphenols, polyethylene glycol ethers of linear alcohols, reaction products of alkylphenols with ethylene oxide and/or propylene oxide, and also fatty acid esters, alkylsulfonates, alkyl sulfates and aryl sulfates.

Useful protective colloids c1) (dispersants) include all substances typically used for this purpose. Preferred examples include natural and synthetic water-soluble polymers such as gelatin, starch and cellulose derivatives, especially cellulose esters and cellulose ethers, such as methyl cellulose, and also polyvinyl alcohols, partly hydrolyzed polyvinyl acetates, lignosulfonates (such as Borresperse® NA, REAX® 88 or Kraftsperse® 25 S), modified naphthalenesulfonates (for instance Morwet D-425), polyvinylpyrrolidones and polyacrylamides. Particular preference is given to using polyvinyl alcohols, partly hydrolyzed polyvinyl acetates and lignosulfonates. Very particular preference is given to polyvinyl alcohols and lignosulfonates. Very particular preference is given to using lignosulfonates.

Useful thickeners c) include organic thickeners and inorganic thickeners. Useful organic thickeners include organic natural or biotechnologically modified or organic synthetic thickeners. Typical synthetic thickeners are Rheostrux® (Croda) or the Thixin® or Thixatrol® series (Elementis). These are typically based on acrylates. Typical organic thickeners are based on xanthan or cellulose (for instance hydroxyethyl or carboxymethyl cellulose) or a combination thereof. Further typical representatives are based on cellulose or lignin. Preference is given to using natural modified thickeners based on xanthan. Typical representatives are, for example, Rhodopol® (Solvay) and Kelzan® (Kelco Corp.), and also Satiaxane® (Cargill). Preference is likewise given to silicas and attapulgites.

Useful preservatives c) include all substances typically present for this purpose in crop protection compositions. Examples include Acticide® SPX (Thor) and Proxel® GXL (Lonza).

Useful defoamers c) include all substances typically usable for this purpose in crop protection compositions.

Preference is given to silane derivatives, such as polydimethylsiloxanes, and magnesium stearate. Typical products are Silcolapse® 484 (Solvay, Silioxane Emulsion) and SAG 1571 (Momentive) used.

Substances that function as cold stabilizers c) may be all of those typically usable for this purpose in crop protection compositions. Examples include urea, glycerol and propylene glycol.

Useful neutralizing agents c) include customary acids and bases. Examples include phosphoric acid, citric acid, sodium hydroxide solution and aqueous ammonia solution.

In the present invention, in formulae, e.g. formula (I), optionally substituted radicals, unless stated otherwise, may be mono- or poly substituted, where the substituents in the case of poly substitutions may be the same or different.

Moreover, even if just one structure or trade name is given, mesomeric and tautomeric forms that are known to the person skilled in the art without any problem are included.

Moreover, in the ranges of preference stated in the present invention, the different levels of preference should be understood such that they can be combined with one another in permutations, but in any case identical levels of preference and especially the most preferred embodiment/level of preference in each case are to be combined with one another and are indeed disclosed as such a combination.

Compositions as described above that consist solely of the essential components (not optional components) should likewise be considered to be disclosed.

Percentages—unless stated otherwise—should be understood as percentages by weight, where the % by weight of the compositions generally add up to 100, or are made up to 100% with the corresponding solvent/dispersant.

The composition of the capsule suspension concentrates of the invention can be varied within a particular range. The proportion of the disperse phase A) in relation to the overall formulation is generally between 10% and 90% by weight, preferably between 30% and 70% by weight, more preferably between 40% and 60% by weight.

The proportion of a) (reaction product a1+a2) is generally between 0.1% and 8% by weight, preferably between 0.2% and 4.5% by weight, more preferably between 0.3% and 2.5% by weight, the proportion of active agrochemical ingredient b) is generally between 1% and 50% by weight, preferably between 5% and 40% by weight, more preferably between 10% and 20% by weight, the proportion of organic solvent L) is generally between 1% and 90% by weight, preferably between 10% and 60% by weight, more preferably between 20% and 40% by weight, the proportion of protective colloids c1) is generally between 0.1% and 5% by weight, preferably between 0.2% and 3% by weight, more preferably between 0.3% and 1.5% by weight, and the proportion of additives c) is generally between 0.1% and 15% by weight, preferably between 0.3% and 10% by weight and more preferably between 0.4% and 3% by weight.

Preferably, the ratio of active agrochemical ingredient b) to the isocyanate mixture a2) is between 7:1 and 40:1, preferably between 8:1 and 20:1, more preferably between 9:1 and 18:1.

If amino-functional compounds are used as component a1), the preferred ratio of aminic isocyanate-reactive groups a1) to the isocyanate mixture a2) is between 0 and 1.

In a preferred embodiment, the capsule suspension concentrates (CS) of the invention are blended with one or more suspension concentrate(s) (SC) to give a ZC formulation.

The present invention likewise provides ZC formulations comprising the CS formulations of the invention and at least one suspension concentrate (SC) comprising
one or more preferably herbicidal active ingredients z),
at least one or more than one thickener c),
one or more anionic emulsifiers e1) and/or
one or more nonionic emulsifiers e2).

Preferred active ingredients z) are active fungicidal, insecticidal and herbicidal ingredients. Preferably, known active ingredients based on inhibition of, for example, acetolactate synthase, acetyl-CoA carboxylase, cellulose synthase, enolpyruvylshikimate-3-phosphate synthase, glutamine synthetase, p-hydroxyphenylpyruvate dioxygenase, phytoene desaturase, photosystem I, photosystem II or protoporphyrinogen oxidase can be employed, as described, for example, in Weed Research 26 (1986) 441-445 or “The Pesticide Manual”, 17th edition, The British Crop Protection Council and the Royal Soc. of Chemistry, 2017 and literature cited therein. Specified hereinafter by way of example are known herbicides which can be combined with the compounds of the invention, these active ingredients being identified either by their common name in the English-language variant according to the International Organization for Standardization (ISO) or by the chemical name or the code number. They always encompass all the use forms, for example acids, salts, esters and also all isomeric forms such as stereoisomers and optical isomers, even if they are not mentioned explicitly.

Typical active ingredients z) are selected from the list comprising: acetochlor, acifluorfen, acifluorfen-sodium, aclonifen, alachlor, allidochlor, alloxydim, alloxydim-sodium, ametryn, amicarbazone, amidochlor, amidosulfuron, aminocyclopyrachlor, aminocyclopyrachlor-potassium, aminocyclopyrachlor-methyl, aminopyralid, amitrole, ammoniumsulfamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bromacil, bromobutide, bromofenoxim, bromoxynil, bromoxynil-butyrate, -potassium, -heptanoate and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, chlorfenac, chlorfenac-sodium, chlorfenprop, chlorflurenol, chlorflurenol-methyl, chloridazon, chlorimuron, chlorimuron-ethyl, chlorophthalim, chlorotoluron, chlorthal-dimethyl, chlorsulfuron, 3-[5-chloro-4-(trifluoromethyl)pyridin-2-yl]-4-hydroxy-1-methylimidazolidin-2-one, cinidon, cinidon-ethyl, cinmethylin, cinosulfuron, clacyfos, clethodim, clodinafop, clodinafop-propargyl, clomazone, clomeprop, clopyralid, cloransulam, cloransulam-methyl, cumyluron, cyanamide, cyanazine, cycloate, cyclopyranil, cyclopyrimorate, cyclosulfamuron, cycloxydim, cyhalofop, cyhalofop-butyl, cyprazine, 2,4-D, 2,4-D-butotyl, -butyl, -dimethylammonium, -diolamin, -ethyl, 2-ethylhexyl, -isobutyl, -isooctyl, -isopropylammonium, -potassium, -triisopropanolammonium and -trolamine, 2,4-DB, 2,4-DB-butyl, -dimethylammonium, isooctyl, -potassium and -sodium, daimuron (dymron), dalapon, dazomet, n-decanol, desmedipham, detosyl-pyrazolate (DTP), dicamba, dichlobenil, 2-(2,4-dichlorobenzyl)-4,4-dimethyl-1,2-oxazolidin-3-one, 2-(2,5-dichlorobenzyl)-4,4-dimethyl-1,2-oxazolidin-3-one, dichlorprop, dichlorprop-P, diclofop, diclofop-methyl, diclofop-P-methyl, diclosulam, difenzoquat, diflufenican, diflufenzopyr, diflufenzopyr-sodium, dimefuron, dimepiperate, dimethachlor, dimethametryn, dimethenamid, dimethenamid-P, dimetrasulfuron, dinitramine, dinoterb, diphenamid, diquat, diquat-dibromid, dithiopyr, diuron, DNOC, endothal, EPTC, esprocarb, ethalfluralin, ethametsulfuron, ethametsulfuron-methyl, ethiozin, ethofumesate, ethoxyfen, ethoxyfen-ethyl, ethoxysulfuron, etobenzanid, F-9600, F-5231, i.e. N-[2-chloro-4-fluoro-5-[4-(3-fluoropropyl)-4,5-dihydro-5-oxo-1H-tetrazol-1-yl]phenyl]ethanesulfonamide, F-7967, i.e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, florpyrauxifen, florpyrauxifen-benzyl, fluazifop, fluazifop-P, fluazifop-butyl, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, flurochloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, -isopropylammonium, -diammonium, -dimethylammonium, -potassium, -sodium and -trimesium, H-9201, i.e. O-(2,4-dimethyl-6-nitrophenyl) O-ethyl isopropylphosphoramidothioate, halauxifen, halauxifen-methyl, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl)ethyl (2,4-dichlorophenoxy)acetate, 4-hydroxy-1-methoxy-5-methyl-3-[4-(trifluoromethyl)pyridin-2-yl]imidazolidin-2-one, 4-hydroxy-1-methyl-3-[4-(trifluoromethyl)pyridin-2-yl]imidazolidin-2-one, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-immonium, imazosulfuron, indanofan, indaziflam, iodosulfuron, iodosulfuron-methyl-sodium, ioxynil, ioxynil-octanoate, -potassium and sodium, ipfencarbazone, isoproturon, isouron, isoxaben, isoxaflutole, karbutilate, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, ketospiradox, lactofen, lenacil, linuron, MCPA, MCPA-butotyl, -dimethylammonium, -2-ethylhexyl, -isopropylammonium, -potassium and -sodium, MCPB, MCPB-methyl, -ethyl and -sodium, mecoprop, mecoprop-sodium, and -butotyl, mecoprop-P, mecoprop-P-butotyl, -dimethylammonium, -2-ethylhexyl and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, methyl isothiocyanate, metobromuron, metolachlor, S-metolachlor, metosulam, metoxuron, metribuzin, metsulfuron, metsulfuron-methyl, molinat, monolinuron, monosulfuron, monosulfuron-ester, MT-5950, i.e. N-[3-chloro-4-(1-methylethyl)-phenyl]-2-methylpentanamide, NGGC-011, napropamide, NC-310, i.e. 4-(2,4-dichlorobenzoyl)-1-methyl-5-benzyloxypyrazole, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxotrione (lancotrione), oxyfluorfen, paraquat, paraquat dichloride, pebulate, pendimethalin, penoxsulam, pentachlorphenol, pentoxazone, pethoxamid, petroleum oils, phenmedipham, picloram, picolinafen, pinoxaden, piperophos, pretilachlor, primisulfuron, primisulfuron-methyl, prodiamine, profoxydim, prometon, prometryn, propachlor, propanil, propaquizafop, propazine, propham, propisochlor, propoxycarbazone, propoxycarbazone-sodium, propyrisulfuron, propyzamide, prosulfocarb, prosulfuron, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, rimsulfuron, saflufenacil, sethoxydim, siduron, simazine, simetryn, sulcotrion, sulfentrazone, sulfometuron, sulfometuron-methyl, sulfosulfuron, SYN-523, SYP-249, i.e. 1-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, 2,3,6-TBA, TCA (trifluoroacetic acid), TCA-sodium, tebuthiuron, tefuryltrione, tembotrione, tepraloxydim, terbacil, terbucarb, terbumeton, terbuthylazin, terbutryn, thenylchlor, thiazopyr, thiencarbazone, thiencarbazone-methyl, thifensulfuron, thifensulfuron-methyl, thiobencarb, tiafenacil, tolpyralate, topramezone, tralkoxydim, triafamone, tri-allate, triasulfuron, triaziflam, tribenuron, tribenuron-methyl, triclopyr, trietazine, trifloxysulfuron, trifloxysulfuron-sodium, trifludimoxazin, trifluralin, triflusulfuron, triflusulfuron-methyl, tritosulfuron, urea sulfate, vernolate, ZJ-0862, i.e. 3,4-dichloro-N-{2-[(4,6-dimethoxypyrimidin-2-yl)oxy]benzyl}aniline.

The active ingredient z) is preferably selected from the list comprising:

anilofos, acephate, benfluralin, bifenthrin, bupirimate, butralin, chloroacetic acid, cyfluthrin, cynmethylin, cypermethrin, demeton-S-methyl sulfone, dimethametryn, dimethoate, dioxabenzofos, diphenylamine, dithiopyr, dodemorph acetate, esfenvalerate, ethalfluralin, ethofumesate, fenazaquin, fenitropan, fenoxycarb, fenuron-TCA, fenvalerate, fluoroglycofen-ethyl, flupyradifuron, flurazole, flurochloridone, fluroxypyr-meptyl, flusilazole, furalaxyl, haloxyfop-etotyl, haloxyfop-methyl, imazalil, ioxynil octanoate, isoprothiolane, metalaxyl, methomyl, methoprotryne, monocrotophos, nitrapyrin, nitrothal-isopropyl, penconazole, pendimethalin, permethrin, propamocarb hydrochloride, propaquizafop, pyrazophos, quizalofop-P-tefuryl, resmethrin, trichloroacetic acid, tetramethrin, thiofanox, triflumizole, pyridaphenthion, 2-phenylphenol, dimethylvinphos, beta-cypermethrin, famphur, clodinafop-propargyl, triazamate, tebufenpyrad, pyrimidifen, aldrin, bromophos, dialifos, pyriminobac-methyl, benzoylprop, benzoylprop-ethyl, binapacryl, camphechlor, chlorfenethol, chlorfenprop, chlorfenprop-methyl, chlorphoxim, crufomate, cyometrinil, 1,1-dichloro-2,2-bis(4-ethylphenyl)ethane, dimetilan, dinobuton, fenson, fenthiaprop, fenthiaprop-ethyl, fluenetil, glyodin, 2-isovalerylindane-1,3-dione, methoxyphenone, 2-methoxyethylmercury chloride, nitrofen, indanofan, acequinocyl, ipsdienol with (S)-cis-verbenol, fenoxanil, pyraclostrobin, trifloxystrobin, cyflufenamid, gamma-cyhalothrin, proquinazid, 2,6-diisopropylnaphthalene, isotianil and 2-[(2,4-dichlorophenyl)methyl]-4,4′-dimethyl-3-isoxazolidinone.

In an alternative preferred embodiment, the active ingredient z) is a herbicide selected from the list comprising:

aclonifen, aminopyralid, benzofenap, bifenox, bromoxynil, bromoxynil butyrate, potassium heptanoate and octanoate, butachlor, cinmethlylin, clomazone, clopyralid, 2,4-D also including the commonly used forms: 2,4-D-butotyl, 2,4-D-butyl, 2,4-D-dimethylammonium, 2,4-D-diolamine (2,4-D-diethanolammonium), 2,4-D-ethyl, 2,4-D-2-ethylhexyl, 2,4-D-isobutyl, 2,4-D-isooctyl, 2,4-D-isopropyl, 2,4-D-isopropylammonium, 2,4-D-sodium, 2,4-D-triisopropanolammonium, 2,4-D-trolamine (2,4-D-triethanolammonium), diflufenican, dimethachlor, dimethenamid, dimethenamid-P, ethoxysulfuron, fenoxaprop, fenoxaprop-P, fenoxaprop-ethyl, fenoxaprop-P-ethyl, fenquinotrione, fentrazamide, florasulam, flufenacet, fluroxypyr, fluroxypyr-meptyl, foramsulfuron, halauxifen-methyl, iodosulfuron, iodosulfuron-methyl-sodium, isoxaflutole, MCPA (4-chloro-2-methylphenoxy)acetic acid, also including the commonly used forms: MCPA-butotyl, MCPA-dimethylammonium, MCPA-isoctyl, MCPA-sodium, MCPA-potassium, MCPA-2-ethylhexyl, mefenacet, mesosulfuron, mesosulfuron-methyl, metazachlor, metolachlor, S-metolachlor, metosulam, metribuzin, napropamid, nicosulfuron, oxadiargyl, oxadiazon, pendimethalin, pethoxamid, picloram, propoxycarbazone, propoxycarbazone-sodium, propyzamid, prosulfocarb, pyrasulfotole, pyroxasulfone, pyroxsulam, quinmerac, tefuryltrione, tembotrione, thiencarbazone, thiencarbazone-methyl, triafamone, DCPMI, and triallate.

Particular preference is given to active herbicidal ingredients. More preferably, z) is selected from the group of:

flufenacet, prosulfocarb, pendimethalin, diflufenican, aclonifen, metribuzin, pyroxasulfone, propoxycarbazone, thiencarbazone-methyl, fenoxaprop, bromoxynil (and esterified variants thereof), halauxifen-methyl, 2,4-D, MCPA.

Very particular preference is given to the active herbicidal ingredients z) flufenacet, pyroxasulfone, diflufenican, aclonifen and metribuzin.

Particular preference is also given to mixtures of one or more active herbicidal ingredients z) selected from the group of:

flufenacet and pethoxamid; flufenacet and aclonifen; flufenacet and metribuzin; flufenacet and halauxifen-methyl; prosulfocarb and diflufenican; prosulfocarb and aclonifen; prosulfocarb and metribuzin; prosulfocarb and flufenacet; prosulfocarb and halauxifen-methyl; pendimethalin and diflufenican; pendimethalin and aclonifen; pendimethalin and metribuzin; pendimethalin and halauxifen-methyl; metribuzin and diflufenican; halauxifen-methyl and diflufenican; flufenacet and diflufenican; metribuzin and aclonifen, halauxifen-methyl and aclonifen; pyroxasulfone and diflufenican; aclonifen and diflufenican; pyroxasulfone and prosulfocarb; pyroxasulfone and aclonifen; pyroxasulfone and metribuzin; pyroxasulfone and flufenacet; pyroxasulfone and halauxifen-methyl or flufenacet and pyroxasulfone and dilflufenican; aclonifen and diflufenican and flufenacet; metribuzin and diflufenican and flufenacet, aclonifen, metribuzin, aclonifen and diflufenican, metribuzin and diflufenican, cinmethylin and DCPMI.

Most preferably, the mixtures are selected from: flufenacet and diflufenican; flufenacet and pyroxasulfone; aclonifen and diflufenican; metribuzin and diflufenican; flufenacet and aclonifen; flufenacet and metribuzin; flufenacet and pyroxasulfone and dilflufenican; aclonifen and diflufenican and flufenacet; metribuzin and diflufenican and flufenacet, cinmethylin and DCPMI.

Preference is further given to using DCPMI, diflufenican and flufenacet as active ingredient, more preferably DCPMT.

It is additionally possible to use mixtures of the abovementioned active ingredients, preferably mixtures in which one mixing partner is DCPMI, more preferably mixtures of DCPMI and diflufenican, DCPMI and flufenacet, and diflufenican and flufenacet.

Components s) used are preferably the following groups of compounds (safeners):
s1) Compounds from the group of heterocyclic carboxylic acid derivatives:
s1^{a}) Compounds of the dichlorophenylpyrazoline-3-carboxylic acid type (S1^{a}), preferably compounds such as 1-(2,4-dichlorophenyl)-5-(ethoxycarbonyl)-5-methyl-2-pyrazoline-3-carboxylic acid, ethyl 1-(2,4-dichlorophenyl)-5-(ethoxycarbonyl)-5-methyl-2-pyrazoline-3-carboxylate (S1-1) (“mefenpyr-diethyl”), and related compounds as described in WO-A-91/07874;
s1^{b}) Derivatives of dichlorophenylpyrazolecarboxylic acid (S1^{b}), preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4) and related compounds as described in EP-A-333 131 and EP-A-269 806;
s1^{c}) Derivatives of 1,5-diphenylpyrazole-3-carboxylic acid (S1, preferably compounds such as ethyl 1-(2,4-dichlorophenyl)-5-phenylpyrazole-3-carboxylate (S1-5), methyl 1-(2-chlorophenyl)-5-phenylpyrazole-3-carboxylate (S-6) and related compounds as described, for example, in EP-A-268554;
s1^{d}) Compounds of the triazolecarboxylic acid type (S1^{d}), preferably compounds such as fenchlorazole (ethyl ester), i.e. ethyl 1-(2,4-dichlorophenyl)-5-trichloromethyl-(H)-1,2,4-triazole-3-carboxylate (S1-7), and related compounds as described in EP-A-174 562 and EP-A-346 620;
s1^{e}) Compounds of the 5-benzyl- or 5-phenyl-2-isoxazoline-3-carboxylic acid or of the 5,5-diphenyl-2-isoxazoline-3-carboxylic acid type (S1^{e}), preferably compounds such as ethyl 5-(2,4-dichlorobenzyl)-2-isoxazoline-3-carboxylate (S1-8) or ethyl 5-phenyl-2-isoxazoline-3-carboxylate (S1-9) and related compounds as described in WO-A-91/08202, or 5,5-diphenyl-2-isoxazolinecarboxylic acid (S1-10) or ethyl 5,5-diphenyl-2-isoxazoline-3-carboxylate (S1-11) (“isoxadifen-ethyl”) or n-propyl 5,5-diphenyl-2-isoxazoline-3-carboxylate (S1-12) or ethyl 5-(4-fluorophenyl)-5-phenyl-2-isoxazoline-3-carboxylate (S-13) as described in patent application WO-A-95/07897.
s2) Compounds from the group of the 8-quinolinoxy derivatives (S2):
s2^{a}) Compounds of the 8-quinolinoxyacetic acid type (S2^{a}), preferably 1-methylhexyl (5-chloro-8-quinolinoxy)acetate (“cloquintocet-mexyl”) (S2-1), 1,3-dimethylbut-1-yl (5-chloro-8-quinolinoxy)acetate (S2-2), 4-allyloxybutyl (5-chloro-8-quinolinoxy)acetate (S2-3), 1-allyloxyprop-2-yl (5-chloro-8-quinolinoxy)acetate (S2-4), ethyl (5-chloro-8-quinolinoxy)acetate (S2-5),
methyl (5-chloro-8-quinolinoxy)acetate (S2-6),
allyl (5-chloro-8-quinolinoxy)acetate (S2-7), 2-(2-propylideneiminoxy)-1-ethyl (5-chloro-8-quinolinoxy)acetate (S2-8), 2-oxoprop-1-yl (5-chloro-8-quinolinoxy)acetate (S2-9) and related compounds as described in EP-A-86 750, EP-A-94 349 and EP-A-191 736 or EP-A-0 492 366, and also (5-chloro-8-quinolinoxy)acetic acid (S2-10), hydrates and salts thereof, for example the lithium, sodium, potassium, calcium, magnesium, aluminum, iron, ammonium, quaternary ammonium, sulfonium or phosphonium salts thereof, as described in WO-A-2002/34048;
s2b) Compounds of the (5-chloro-8-quinolinoxy)malonic acid type (S2^{b}), preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.
s3) Compounds of the dichloroacetamide type (S3), which are frequently used as pre-emergence safeners (soil-acting safeners), for example
“dichlormid” (N,N-diallyl-2,2-dichloroacetamide) (S3-1),
“R-29148” (3-dichloroacetyl-2,2,5-trimethyl-1,3-oxazolidine) from Stauffer (S3-2),
“R-28725” (3-dichloroacetyl-2,2-dimethyl-1,3-oxazolidine) from Stauffer (S3-3),
“benoxacor” (4-dichloroacetyl-3,4-dihydro-3-methyl-2H-1,4-benzoxazine) (S3-4),
“PPG-1292” (N-allyl-N-[(1,3-dioxolan-2-yl)methyl]dichloroacetamide) from PPG Industries (S3-5),
“DKA-24” (N-allyl-N-[(allylaminocarbonyl)methyl]dichloroacetamide) from Sagro-Chem (S3-6),
“AD-67” or “MON 4660” (3-dichloroacetyl-1-oxa-3-azaspiro[4.5]decane) from Nitrokemia or Monsanto (S3-7),
“TI-35” (1-dichloroacetylazepane) from TRI-Chemical RT (S3-8),
“diclonon” (dicyclonon) or “BAS145138” or “LAB145138” (S3-9)
((RS)-1-dichloroacetyl-3,3,8a-trimethylperhydropyrrolo[1,2-a]pyrimidin-6-one) from BASF,
“furilazole” or “MON 13900” ((RS)-3-dichloroacetyl-5-(2-furyl)-2,2-dimethyloxazolidine) (S3-10), and the (R) isomer thereof (S3-11).
s4) Compounds from the class of the acylsulfonamides (S4):
s4^{a}) N-Acylsulfonamides of the formula (S4) and salts thereof, as described in WO-A-97/45016,

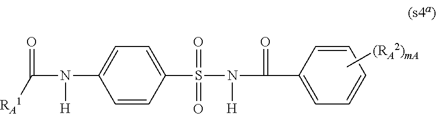

in which
R_{A}¹ represents (C₁-C₆)-alkyl, (C₃-C₆)-cycloalkyl, where the 2 latter radicals are substituted by v_{A} substituents from the group of halogen, (C₁-C₄)-alkoxy, (C₁-C₆)-haloalkoxy and (C₁-C₄)-alkylthio and, in the case of cyclic radicals, also by (C₁-C₄)-alkyl and (C₁-C₄)-haloalkyl; R_{A}² represents halogen, (C₁-C₄)-alkyl, (C₁-C₄)-alkoxy, CF₃;
m_{A} represents 1 or 2;
v_{A} represents 0, 1, 2 or 3;
s4^{b}) Compounds of the 4-(benzoylsulfamoyl)benzamide type of the formula (S4^{b}) and salts thereof, as described in WO-A-99/16744,

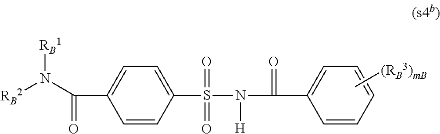

in which
R_{B}¹, R_{B}² independently of one another represent hydrogen, (C₁-C₆)-alkyl, (C₃-C₆)-cycloalkyl, (C₃-C₆)-alkenyl, (C₃-C₆)-alkynyl,
R_{B}³ represents halogen, (C₁-C₄)-alkyl, (C₁-C₄)-haloalkyl or (C₁-C₄)-alkoxy and
m_{B} represents 1 or 2,
e.g. those in which
R_{B}¹=cyclopropyl, R_{B}²=hydrogen and (R_{B}³)=2-OMe (“cyprosulfamide”, 4-1),
R_{B}¹=cyclopropyl, R_{B}²=hydrogen and (R_{B}³)=5-Cl-2-OMe (S4-2),
R_{B}¹=ethyl, R_{B}²=hydrogen and (R_{B}³)=2-OMe (S4-3),
R_{B}¹=isopropyl, R_{B}²=hydrogen and (R_{B}³)=5-Cl-2-OMe (S4-4) and
R_{B}¹=isopropyl, R_{B}²=hydrogen and (R_{B}³)=2-OMe (S4-5);
s4^{c}) Compounds from the class of the benzoylsulfamoylphenylureas of the formula (S4^{c}), as described in EP-A-365484,

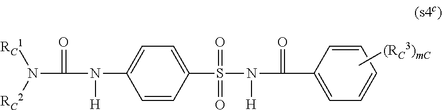

in which
R_{C}¹, R_{C}² independently of one another represent hydrogen, (C₁-C₈)-alkyl, (C₃-C₅)-cycloalkyl, (C₃-C₆)-alkenyl, (C₃-C₆)-alkynyl,
R_{C}³ represents halogen, (C₁-C₄)-alkyl, (C₁-C₄)-alkoxy, CF₃ and
m_{C} represents 1 or 2;
for example
1-[4-(N-2-methoxybenzoylsulfamoyl)phenyl]-3-methylurea,
1-[4-(N-2-methoxybenzoylsulfamoyl)phenyl]-3,3-dimethylurea,
1-[4-(N-4,5-dimethylbenzoylsulfamoyl)phenyl]-3-methylurea;
s₄^{d}) Compounds of the N-phenylsulfonylterephthalamide type of the formula (S4) and salts thereof, which are known, for example, from CN 101838227,

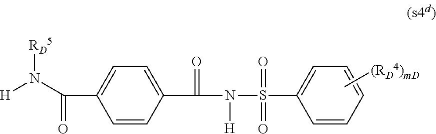

in which
R_{D}⁴ represents halogen, (C₁-C₄)-alkyl, (C₁-C₄)-alkoxy, CF₃;
m_{D} represents 1 or 2;
R_{D}⁵ represents hydrogen, (C₁-C₆)-alkyl, (C₃-C₆)-cycloalkyl, (C₂-C₆)-alkenyl, (C₂-C₆)-alkynyl, (C₅-C₆)-cycloalkenyl.
s5) Compounds from the class of the hydroxyaromatics and the aromatic-aliphatic carboxylic acid derivatives (S5), for example
ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicylic acid, 2-hydroxycinnamic acid, 2,4-dichlorocinnamic acid, as described in WO-A-2004/084631, WO-A-2005/015994, WO-A-2005/016001.
s6) Active ingredients from the class of the 1,2-dihydroquinoxalin-2-ones (S6), for example
1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulfonylaminoethyl)-3-(2-thienyl)-1,2-dihydroquinoxalin-2-one, as described in WO-A-2005/112630.
s7) Compounds from the class of the diphenylmethoxyacetic acid derivatives (S7), for example methyl diphenylmethoxyacetate (CAS Reg. No. 41858-19-9) (S7-1), ethyl diphenylmethoxyacetate or diphenylmethoxyacetic acid, as described in WO-A-98/38856.
s8) Compounds of the formula (S8), as described in WO-A-98/27049,
in which

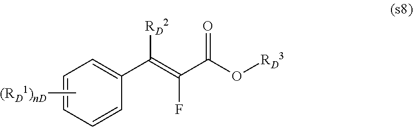

the symbols and indices are defined as follows:
R_{D}¹ represents halogen, (C₁-C₄)-alkyl, (C₁-C₄)-haloalkyl, (C₁-C₄)-alkoxy, (C₁-C₄)-haloalkoxy,
R_{D}² represents hydrogen or (C₁-C₄)-alkyl,
R_{D}³ represents hydrogen, (C₁-C₅)-alkyl, (C₂-C₄)-alkenyl, (C₂-C₄)-alkynyl or aryl, where each of the aforementioned carbon-containing radicals is unsubstituted or substituted by one or more, preferably up to three, identical or different radicals from the group consisting of halogen and alkoxy; or salts thereof,
n_{D} represents an integer from 0 to 2.
s9) Compounds from the class of the 3-(5-tetrazolylcarbonyl)-2-quinolones (S9), for example 1,2-dihydro-4-hydroxy-1-ethyl-3-(5-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No. 95855-00-8), as described in WO-A-1999/000020.
s10) Compounds of the formula (S10^{a}) or (S10^{b})
   as described in WO-A-2007/023719 and WO-A-2007/023764,
in which

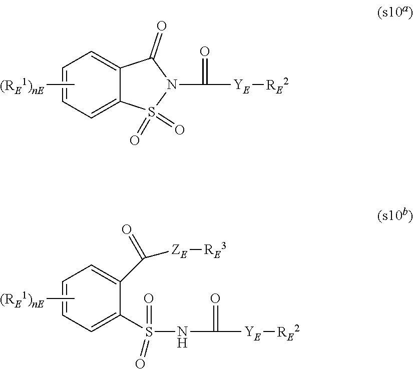

R_{E}¹ represents halogen, (C₁-C₄)-alkyl, methoxy, nitro, cyano, CF₃, OCF₃,
Y_{E}, Z_{E} independently of one another represent O or S,
n_{E} represents an integer from 0 to 4,
R_{E}² represents (C₁-C₁₆)-alkyl, (C₂-C₆)-alkenyl, (C₃-C₆)-cycloalkyl, aryl; benzyl, halobenzyl,
R_{E}³ represents hydrogen or (C₁-C₆)-alkyl.
s11) Compounds of the oxyimino compound type (S11), which are known as seed-dressing agents, for example
“oxabetrinil” ((Z)-1,3-dioxolan-2-ylmethoxyimino(phenyl)acetonitrile) (S11-1), which is known as a seed-dressing safener for millet/sorghum against metolachlor damage,
   “fluxofenim” (1-(4-chlorophenyl)-2,2,2-trifluoro-1-ethanone O-(1,3-dioxolan-2-ylmethyl)oxime) (S11-2), which is known as a seed-dressing safener for millet/sorghum against metolachlor damage, and
   “cyometrinil” or “CGA-43089” ((Z)-cyanomethoxyimino(phenyl)acetonitrile) (S11-3), which is known as a seed-dressing safener for millet/sorghum against metolachlor damage.
s12) Compounds from the class of the isothiochromanones (S12), for example methyl [(3-oxo-1H-2-benzothiopyran-4(3H)-ylidene)methoxy]acetate (CAS Reg. No. 205121-04-6) (S12-1) and related compounds from WO-A-1998/13361.
s13) One or more compounds from group (S13):
   “naphthalic anhydride” (1,8-naphthalenedicarboxylic anhydride) (S13-1), which is known as a seed-dressing safener for corn against thiocarbamate herbicide damage,
   “fenclorim” (4,6-dichloro-2-phenylpyrimidine) (S13-2), which is known as a safener for pretilachlor in sown rice,
   “flurazole” (benzyl 2-chloro-4-trifluoromethyl-1,3-thiazole-5-carboxylate) (S13-3), which is known as a seed-dressing safener for millet/sorghum against alachlor and metolachlor damage,
   “CL 304415” (CAS Reg. No. 31541-57-8)
   (4-carboxy-3,4-dihydro-2H-1-benzopyran-4-acetic acid) (S13-4) from American Cyanamid, which is known as a safener for corn against damage by imidazolinones,
   “MG 191” (CAS Reg. No. 96420-72-3) (2-dichloromethyl-2-methyl-1,3-dioxolane) (S13-5) from Nitrokemia, which is known as a safener for corn,
   “MG 838” (CAS Reg. No. 133993-74-5)
   (2-propenyl 1-oxa-4-azaspiro[4.5]decane-4-carbodithioate) (S13-6) from Nitrokemia
   “disulfoton” (0,0-diethyl S-2-ethylthioethylphosphorodithioate) (S13-7),
   “dietholate” (0,0-diethyl O-phenyl phosphorothioate) (S13-8),
   “mephenate” (4-chlorophenyl methylcarbamate) (S13-9).
s14) Compounds which, in addition to herbicidal action against harmful plants, also have safener action on crop plants such as rice, for example
“dimepiperate” or “MY-93” (S-1-methyl 1-phenylethylpiperidine-1-carbothioate), which is known as a safener for rice against damage by the herbicide molinate,
   “daimuron” or “SK 23” (1-(1-methyl-1-phenylethyl)-3-p-tolylurea), which is known as a safener for rice against damage by the herbicide imazosulfuron,
   “cumyluron”=“JC-940” (3-(2-chlorophenylmethyl)-1-(1-methyl-1-phenylethyl)urea, see JP-A-60087254), which is known as a safener for rice against damage by some herbicides,
   “methoxyphenone” or “NK 049” (3,3′-dimethyl-4-methoxybenzophenone), which is known as a safener for rice against damage by some herbicides,
   “CSB” (1-bromo-4-(chloromethylsulfonyl)benzene) from Kumiai, (CAS Reg. No. 54091-06-4), which is known as a safener against damage by some herbicides in rice.
s15) Compounds of the formula (S15) or tautomers thereof
   as described in WO-A-2008/131861 and WO-A-2008/131860

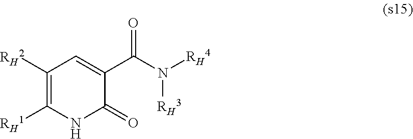

in which
R_{H}¹ represents a (C₁-C₆)-haloalkyl radical and
R_{H}² represents hydrogen or halogen and
R_{H}³, R_{H}⁴ independently of one another represent hydrogen, (C₁-C₆)-alkyl, (C₂-C₁₆)-alkenyl or (C₂-C₁₆)-alkynyl,
   where each of the 3 latter radicals is unsubstituted or substituted by one or more radicals from the group of halogen, hydroxyl, cyano, (C₁-C₄)-alkoxy, (C₁-C₄)-haloalkoxy, (C₁-C₄)-alkylthio, (C₁-C₄)-alkylamino, di[(C₁-C₄)-alkyl]amino, [(C₁-C₄)-alkoxy]carbonyl, [(C₁-C₄)-haloalkoxy]carbonyl, (C₃-C₆)-cycloalkyl which is unsubstituted or substituted, phenyl which is unsubstituted or substituted, and heterocyclyl which is unsubstituted or substituted, or (C₃-C₆)-cycloalkyl, (C₄-C₆)-cycloalkenyl, (C₃-C₆)-cycloalkyl fused on one side of the ring to a 4 to 6-membered saturated or unsaturated carbocyclic ring, or (C₄-C₆)-cycloalkenyl fused on one side of the ring to a 4 to 6-membered saturated or unsaturated carbocyclic ring,
      where each of the 4 latter radicals is unsubstituted or substituted by one or more radicals from the group of halogen, hydroxyl, cyano, (C₁-C₄)-alkyl, (C₁-C₄)-haloalkyl, (C₁-C₄)-alkoxy, (C₁-C₄)-haloalkoxy, (C₁-C₄)-alkylthio, (C₁-C₄)-alkylamino, di[(C₁-C₄)-alkyl]amino, [(C₁-C₄)-alkoxy]carbonyl, [(C₁-C₄)-haloalkoxy]carbonyl, (C₃-C₆)-cycloalkyl which is unsubstituted or substituted, phenyl which is unsubstituted or substituted, and heterocyclyl which is unsubstituted or substituted,
   or
R_{H}³ represents (C₁-C₄)-alkoxy, (C₂-C₄)-alkenyloxy, (C₂-C₆)-alkynyloxy or (C₂-C₄)-haloalkoxy and
R_{H}⁴ represents hydrogen or (C₁-C₄)-alkyl or
R_{H}³ and R_{H}⁴ together with the directly attached nitrogen atom represent a four- to eight-membered heterocyclic ring which, as well as the nitrogen atom, may also contain further ring heteroatoms, preferably up to two further ring heteroatoms from the group of N, O and S, and which is unsubstituted or substituted by one or more radicals from the group of halogen, cyano, nitro, (C₁-C₄)-alkyl, (C₁-C₄)-haloalkyl, (C₁-C₄)-alkoxy, (C₁-C₄)-haloalkoxy and (C₁-C₄)-alkylthio.
s16) Compounds which are used primarily as herbicides but also have safener action on crop plants, for example
(2,4-dichlorophenoxy)acetic acid (2,4-D),
(4-chlorophenoxy)acetic acid,
(R,S)-2-(4-chloro-o-tolyloxy)propionic acid (mecoprop),
4-(2,4-dichlorophenoxy)butyric acid (2,4-DB),
(4-chloro-o-tolyloxy)acetic acid (MCPA),
4-(4-chloro-o-tolyloxy)butyric acid,
4-(4-chlorophenoxy)butyric acid,
3,6-dichloro-2-methoxybenzoic acid (dicamba),
1-(ethoxycarbonyl)ethyl 3,6-dichloro-2-methoxybenzoate (lactidichlor-ethyl).

Very particularly preferred safeners s) are selected from the group of isoxadifen-ethyl, cyprosulfamide, cloquintocet-mexyl and mefenpyr-diethyl. Particular preference is given to mefenpyr-diethyl and cloquintocet-mexyl. Very particular preference is given to mefenpyr-diethyl. Very particular preference is given to cereal safeners.

Suitable anionic dispersants e1), such as emulsifiers, surfactants, wetting agents and dispersers, are, for example, alkali metal, alkaline earth metal or ammonium salts of sulfonates, sulfates, phosphates, carboxylates and mixtures thereof, for example the salts of alkylsulfonic acids or alkylphosphoric acids and alkylarylsulfonic or alkylarylphosphoric acids, diphenylsulfonates, alpha-olefinsulfonates, lignosulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols or of fatty acid esters. Examples of phosphates are phosphate esters. Examples of carboxylates are alkyl carboxylates and carboxylated alcohol ethoxylates or alkylphenol ethoxylates. Likewise suitable is the group of anionic emulsifiers of the alkali metal, alkaline earth metal and ammonium salts of the polystyrenesulfonic acids, salts of the polyvinylsulfonic acids, salts of the alkylnaphthalenesulfonic acids, salts of alkylnaphthalenesulfonic acid-formaldehyde condensation products, salts of condensation products of naphthalenesulfonic acid, phenolsulfonic acid and formaldehyde. Examples are calcium dodecylbenzenesulfonate such as Rhodocal® 70/B (Solvay), Phenylsulfonat CA100 (Clariant) or isopropylammonium dodecylbenzenesulfonates such as Atlox© 3300B (Croda).

Further typical representatives include Phenylsulfonat CA (calcium dodecylbenzenesulfonate), Soprophor® products (optionally esterified derivatives of tristyrylphenol ethoxylates), Emulsogen® 3510 (alkylated EO/PO copolymer), Emulsogen® EL 400 (ethoxylated castor oil), Tween® products (fatty acylated sorbitan ethoxylates), Calsogen® AR 100 (calcium dodecylbenzenesulfonate). Preference is given to combinations of salts of alkylated aromatic sulfonic acids, such as calcium phenylsulfonate and/or Calsogen® AR 100, with alkylated copolymers of ethylene oxide and propylene oxide, such as Emulsogen® 3510. Particular preference is given to combinations of salts of dodecylbenzenesulfonic acid, such as Calsogen® AR 100, with alkylated copolymer of ethylene oxide and propylene oxide, such as Emulsogen® 3510.

Examples of further anionic emulsifiers e1) from the group of the naphthalenesulfonates are Galoryl® MT 800 (sodium dibutylnaphthalenesulfonate), Morwet IP (sodium diisopropylnaphthalenesulfonate) and Nekal® BX (alkylnaphthalenesulfonate). Examples of anionic surfactants from the group of the condensates of naphthalenesulfonates with formaldehyde are Galoryl® DT 201 (naphthalenesulfonic acid hydroxy polymer with formaldehyde and methylphenol sodium salt), Galoryl® DT 250 (condensate of phenol- and naphthalenesulfonates), Reserve® C (condensate of phenol- and naphthalenesulfonates) or Morwet D-425, Tersperse® 2020. Preference is given to 1,2-dibutyl- or -diisobutyl-substituted naphthalenesulfonates, for example products such as Galoryl® MT 800 (CFPI-Nufarm) and Nekal® BX (BASF). Further typical surfactants are Soprophor® 3D33, Soprophor® 4D384, Soprophor® BSU, Soprophor® CY/8 (Solvay) and Hoe5 S3474, and in the form of the Sapogenat® T products (Clariant), for example Sapogenat® T 100.

Useful nonionic dispersants e2), such as emulsifiers, wetting agents, surfactants and dispersers, include standard surface-active substances present in formulations of active agrochemical ingredients. Examples include ethoxylated nonylphenols, reaction products of linear or branched alcohols with ethylene oxide and/or propylene oxide, ethylene oxide-propylene oxide block copolymers, end group-capped and non-end group-capped alkoxylated linear and branched, saturated and unsaturated alcohols (e.g. butoxy polyethylenepropylene glycols), reaction products of alkylphenols with ethylene oxide and/or propylene oxide, ethylene oxide-propylene oxide block copolymers, polyethylene glycols and polypropylene glycols, and also fatty acid esters, fatty acid polyglycol ether esters, alkylsulfonates, alkylsulfates, arylsulfates, ethoxylated arylalkylphenols, for example tristyrylphenol ethoxylate having an average of 16 ethylene oxide units per molecule, and also ethoxylated and propoxylated arylalkylphenols, and also sulfated or phosphated arylalkylphenol ethoxylates or ethoxy- and propoxylates. Particular preference is given to tristyrylphenol alkoxylates and fatty acid polyglycol ether esters. Very particular preference is given to tristyrylphenol ethoxylates, tristyrylphenol ethoxy propoxylates and castor oil polyglycol ether esters, in each case individually or in mixtures. Additives may additionally be useful, such as surfactants or esters of fatty acids, which contribute to improvement in biological efficacy. Suitable nonionic emulsifiers b2) are, for example, Soprophor® 796/P, Lucramul® C030, Lucramul® HOT, Lucramul® PSI 100 or Synperonic® T304.

Suitable nonionic dispersers e2) may likewise be selected from the group comprising polyvinylpyrrolidone (PVP), polyvinyl alcohol, copolymer of PVP and dimethylaminoethyl methacrylate, butylated PVP, copolymer of vinyl chloride and vinyl acetate, and partially hydrolyzed vinyl acetate, phenolic resins, modified cellulose types, for example Luviskol® (polyvinylpyrrolidone), Mowiol® (polyvinyl alcohol) or modified cellulose. Preference is given to polyvinylpyrrolidone types, particular preference to types of low molecular weight such as Luviskol® K30 or Sokalan® K30.

Useful further nonionic emulsifiers e2) from the group of the di- and triblock copolymers of alkylene oxides are, for example, compounds based on ethylene oxide and propylene oxide, having mean molar masses between 200 and 10 000 and preferably 1000 to 4000 g/mol, where the proportion by mass of the polyethoxylated block varies between 10% and 80%, for example the Synperonic® PE series (Unigema), the Pluronic® PE series (BASF), the VOP® 32 or Genapol® PF series (Clariant).

For the ZC formulations, it is possible to add carrier materials f) to the SC formulations.

The carrier materials f) are preferably selected from the group comprising minerals, carbonates, sulfates and phosphates of alkaline earth metals and earth metals, such as calcium carbonate, polymeric carbohydrates, silicas, (natural) framework silicates, such as kaolin. Typical representatives of suitable fillers c) are, for example, AgsorbR LVMR-GA (attapulgite), HarborliteR 300 (perlite), CollysR HV (modified starch), OmyaR chalk (calcium carbonate), KaolinR Tec 1 (kaolin, aluminum hydrosilicate), SteamicR OOS (talc, magnesium silicate).

For f), preference is further given here to natural framework silicates and calcium carbonate products such as Omya® chalk (calcium carbonate), Kaolin Tec 1® (kaolin) and Harborlite® 300 (perlite), particular preference to natural framework silicates such as Kaolin®, Tec® 1 (kaolin, aluminum hydrosilicate) and Harborlite® 300 (perlite). Further fillers in the SC formulations of the invention are selected from the group comprising minerals, carbonates, sulfates and phosphates of alkaline earth metals and earth metals, such as calcium carbonate, polymeric carbohydrates, framework silicates, such as precipitated silicas having low absorption, and natural framework silicates, such as kaolin. Typical representatives of suitable fillers c) are, for example, Agsorb® LVM®-GA (attapulgite), Harborlite® 300 (perlite), Collys® HV (modified starch), Omya® chalk (calcium carbonate), Kaolin® Tec 1 (kaolin, aluminum hydrosilicate), Steamic® OOS (talc, magnesium silicate). Suitable examples are modified natural silicates such as chemically modified bentonites, hectorites, attapulgites, montmorillonites, smectites or other silicate minerals such as Bentone (Elementis), Attagel® (Engelhard), Agsorb® (Oil-Dri Corporation) or Hectorite® (Akzo Nobel), or the Van Gel series (R.T. Vanderbilt).

Particular preference is given to carrier materials c) selected from the group of the high absorbency carriers having an absorbency of at least 200 g of dibutyl phthalate per 100 g of carrier material (BET surface according to ISO 9277), for example high absorbency synthetic fumed silica (Sipernat® types) and pyrogenic silica (Aerosil® types).

The capsule suspension concentrates of the invention are of excellent suitability for application of the active agrochemical ingredients present to plants and/or the habitat thereof. They ensure the release of the active components in the respective desired amount over a relatively long period of time.

The capsule suspension concentrates of the invention can be used in practice either as they are or after prior dilution with water. Application is effected by customary methods, i.e., for example by pouring or spraying.

The application rate of capsule suspension concentrates of the invention may be varied within a relatively wide range. It is guided by the active agrochemical ingredients in question and by the content thereof in the microcapsule formulations.

A preferred use of the capsule suspension concentrates of the invention is as a herbicide in cereals and oilseed rape, most preferably in winter barley, and in this context by the pre-emergence and post-emergence methods. Preference is therefore given to use in an autumn application shortly after the sowing of the cereal and shortly before or shortly after germination of the weeds and in particular weed grasses.

The capsule suspension concentrates of the invention can be produced by known processes, for example as mixed formulations of the individual components, optionally with further active ingredients, additives and/or customary formulation auxiliaries, and these are then applied in a customary manner diluted with water, or as tankmixes by joint dilution of the separately formulated or partly separately formulated individual components with water. Likewise possible is the application at different times (split application) of the separately formulated or partly separately formulated individual components. It is also possible to apply the individual components or the capsule suspension concentrates of the invention in a plurality of portions (sequential application), for example by pre-emergence applications followed by post-emergence applications or by early post-emergence applications followed by medium or late post-emergence applications. Preference is given to the joint or immediately successive application of the active ingredients in the respective combination.

The present invention thus further provides a method of controlling unwanted plants in plant crops, which is characterized in that the capsule suspension concentrates of the invention are deployed on the plants (for example harmful plants such as mono- or dicotyledonous weeds or unwanted crop plants) or the area on which the plants grow.

Unwanted plants are understood to mean all plants which grow at sites where they are unwanted. These can be, for example, harmful plants (e.g. mono- or dicotyledonous weeds or unwanted crop plants).

Monocotyledonous weeds come, for example, from the genera: Aegilops, Agropyron, Agrostis, Alopecurus, Apera, Avena, Brachiaria, Bromus, Cenchrus, Commelina, Cynodon, Cyperus, Dactyloctenium, Digitaria, Echinochloa, Eleocharis, Eleusine, Eragrostis, Eriochloa, Festuca, Fimbristylis, Heteranthera, Imperata, Ischaemum, Leptochloa, Lolium, Monochoria, Panicum, Paspalum, Phalaris, Phleum, Poa, Rottboellia, Sagittaria, Scirpus, Setaria, and Sorghum.

Dicotyledonous weeds come, for example, from the genera Abutilon, Amaranthus, Ambrosia, Anoda, Anthemis, Aphanes, Artemisia, Atriplex, Bellis, Bidens, Capsella, Carduus, Cassia, Centaurea, Chenopodium, Cirsium, Convolvulus, Datura, Desmodium, Emex, Erysimum, Euphorbia, Galeopsis, Galinsoga, Galium, Geranium, Hibiscus, Ipomoea, Kochia, Lamium, Lepidium, Lindernia, Matricaria, Mentha, Mercurialis, Mullugo, Myosotis, Papaver, Pharbitis, Plantago, Polygonum, Portulaca, Ranunculus, Raphanus, Rorippa, Rotala, Rumex, Salsola, Senecio, Sesbania, Sida, Sinapis, Solanum, Sonchus, Sphenoclea, Stellaria, Taraxacum, Thlaspi, Trifolium, Urtica, Veronica, Viola and Xanthium.

The capsule suspension concentrates of the invention are preferably used for control of weed grasses.

The invention further provides for the use of the formulations of the invention in vegetable crops and here particularly in potatoes.

The invention also provides for the use of the capsule suspension concentrates of the invention for control of unwanted plant growth, preferably in crops of useful plants.

If the capsule suspension concentrates of the invention are applied to the soil surface before germination, either the emergence of the weed seedlings is prevented completely or the weeds grow until they have reached the cotyledon stage, but then they stop growing and ultimately die completely after three to four weeks have passed.

When the capsule suspension concentrates of the invention compositions are applied post-emergence to the green parts of the plants, growth likewise stops rapidly a very short time after the treatment, and the weed plants remain at the growth stage at the time of application, or they die completely after a certain time, such that competition by the weeds, which is harmful to the crop plants, is thus eliminated very early and in a sustained manner.

The capsule suspension concentrates of the invention are notable for a rapid onset and long duration of herbicidal action. Said properties and advantages are beneficial in practical weed control in order to keep agricultural crops clear of unwanted competing plants and hence to ensure and/or increase the yields in terms of quality and quantity. These novel compositions markedly exceed the technical state of the art with a view to the properties described.

Even though the capsule suspension concentrates of the invention have excellent herbicidal activity against monocotyledonous and dicotyledonous weeds, there is only insignificant damage, if any, to crop plants of economically important crops, for example dicotyledonous crops such as soya, cotton, oilseed rape, sugar beet, or gramineous crops such as wheat, barley, rye, oats, millet/sorghum, rice or corn. For these reasons, the capsule suspension concentrates of the invention are highly suitable for selective control of unwanted plant growth in agriculturally useful plants or in ornamental plants.

In addition, the capsule suspension concentrates of the invention have excellent growth-regulatory properties in crop plants. They intervene in the plants' own metabolism with regulatory effect, and can thus be used for the controlled influencing of plant constituents and to facilitate harvesting, for example by triggering desiccation and stunted growth. In addition, they are also suitable for general control and inhibition of unwanted vegetative growth without killing the plants. Inhibition of vegetative growth plays a major role for many mono- and dicotyledonous crops since this can reduce or completely prevent lodging.

By virtue of their herbicidal and plant growth regulatory properties, the capsule suspension concentrates of the invention can also be used to control harmful plants in crops of genetically modified plants which are known or are yet to be developed. In general, the transgenic plants are characterized by particular advantageous properties, for example by resistances to certain pesticides, in particular certain herbicides, resistances to plant diseases or pathogens of plant diseases, such as certain insects or microorganisms such as fungi, bacteria or viruses. Other specific characteristics relate, for example, to the harvested material with regard to quantity, quality, storability, composition and specific constituents. For instance, there are known transgenic plants with an elevated starch content or altered starch quality, or those with a different fatty acid composition in the harvested material.

Preference is given to the use of the capsule suspension concentrates of the invention in economically important transgenic crops of useful and ornamental plants, for example of gramineous crops such as wheat, barley, rye, oats, millet/sorghum, rice, oilseed rape and corn. Preferably, the compositions of the invention can be used as herbicides in crops of useful plants which are resistant, or have been made resistant by genetic engineering, to the phytotoxic effects of the herbicides. Particular preference is given to use on wheat, barley, rye and oilseed rape, preferably winter oilseed rape.

When the capsule suspension concentrates of the invention are employed in transgenic crops, not only do the effects toward harmful plants observed in other crops occur, but frequently also effects which are specific to application in the particular transgenic crop, for example an altered or specifically widened spectrum of weeds which can be controlled, altered application rates which can be used for the application, preferably good combinability with the herbicides to which the transgenic crop is resistant, and influencing of growth and yield of the transgenic crop plants.

The present invention also further provides a method of controlling unwanted plant growth, preferably in plant crops such as cereals (e.g. wheat, barley, rye, oats, rice, corn, millet/sorghum), more preferably in monocotyledonous crops such as cereals, for example wheat, barley, rye, oats, crossbreeds thereof, such as triticale, rice, corn and millet/sorghum, wherein one or more capsule suspension concentrates of the invention are applied to the harmful plants, plant parts, plant seeds or the area in which the plants grow, for example the area under cultivation in the. Preferably, the capsule suspension concentrates of the invention are applied by pre-emergence and post-emergence methods. More preferably pre-emergence.

The invention therefore also provides for the use of the capsule suspension concentrates of the invention for control of harmful plants in transgenic crop plants.

The invention is illustrated by the examples below.

### EXAMPLES

Substances and abbreviations used:

The terms used in the examples below have the following meanings:

| | |
|---|---|
| mefenpyr-diethyl | diethyl (RS)-1-(2,4-dichlorophenyl)-5-methyl-2-pyrazoline-3,5-dicarboxylate |
| | (Bayer AG), melting range 50-55° C., MPR |
| flufenacet | 4′-fluoro-N-isopropyl-2-(5-trifluoromethyl-1,3,4-thiadiazol-2-yloxy) acetanilide |
| | (Bayer AG), FFA |
| diflufenican | 2′,4′-difluoro-2-(α,α,α-trifluoro-m-tolyloxy) nicotinanilide (Bayer AG), DFF |
| cloquintocet-mexyl | (RS)-1-methylhexyl (5-chloroquinolin-8-yloxy) acetate (Syngenta), melting |
| | range 60-70° C., CQM |
| DCPMI | 2-[(2,4-dichlorophenyl)methyl]-4,4′-dimethyl-3-isoxazolidinone (CAS number |
| | 81777-95-9 or IUPAC 2-(2,4-dichlorobenzyl)-4,4-dimethyl-1,2-oxazolidin-3-one, |
| | abbreviated hereinafter to DCPMI) |
| Morwet ® D-425 | naphthalenesulfonic acid/formaldehyde condensate, sodium salt (Akzo Nobel) |
| Pluronic ® PE 10500 | propylene oxide-ethylene oxide (PO-EO) block polymer (BASF) |
| citric acid | polybasic organic acid |
| Rhodopol ® G | xanthan derivative (Solvay) |
| Silcolapse ® 426R, 411 | silicone defoamer (Solvay) |
| glycerol | antifreeze |
| Proxel ® GXL | preservative (biocide, Proxel) |
| Solvesso ® 200 ND | mineral oil, ExxonMobil, naphthalene-free |
| Desmodur ® 44V20L | polymeric MDI, Covestro AG, functionality 2.7. |
| HDA | hexamethylene-1,6-diam, BASF |
| Reax 88B | lignosulfonate from MeadWestVaco |

### Production Example

### Example 1 (Inventive) (CS Formulation)

14.23 g of DCPMI and 7.14 g of mefenpyr-diethyl were dissolved at 50° C. in 21.4 g of Solvesso® 200 ND.

The solution was added to a mixture of 1.1 g of Desmodur® 44V20L, 1.51 g of Reax 88B, and also 0.2 g of Silcolapse® 426R and 0.18 g of Kathon® CG/ICP in 53.78 g of water together with 0.36 g of hexamethylenediamine. The mixture was dispersed with a disperser at 15 000 rpm for 10 minutes. The resulting reaction mixture is heated up to 70° C. within one hour and kept at 70° C. with gentle stirring for a further 4 hours. After subsequent cooling to room temperature, the mixture is thickened with 0.1 g of Rhodopol® G. In this way, a microcapsule formulation having a DCPMI content of 150 g/l and 75 g/l mefenpyr-diethyl and a particle size of 8.3 μm (d90) is obtained.

The result is a CS formulation having a density of 1.05.

### Example 2 (Inventive) (CS Formulation)

14.23 g of DCPMI and 7.14 g of cloquintocet-mexyl were dissolved at 50° C. in 21.4 g of Solvesso® 200 ND.

The solution was added to a mixture of 1.1 g of Desmodur® 44V20L, 1.51 g of Reax 88B, and also 0.2 g of Silcolapse® 426R and 0.18 g of Kathon® CG/ICP in 53.78 g of water together with 0.36 g of hexamethylenediamine. The mixture was dispersed with a disperser at 15 000 rpm for 10 minutes. The resulting reaction mixture is heated up to 70° C. within one hour and kept at 70° C. with gentle stirring for a further 4 hours. After subsequent cooling to room temperature, the mixture is thickened with 0.1 g of Rhodopol® G. In this way, a microcapsule formulation (CS) having a DCPMI content of 150 g/l and 75 g/l cloquintocet-mexyl and a particle size of 8.3 μm (d90) is obtained.

### Comparative Example 1 (CS Formulation)

14.23 g of DCPMI was dissolved at 50° C. in 21.4 g of Solvesso® 200 ND.

The solution was added to a mixture of 1.1 g of Desmodur® 44V20L, 1.51 g of Reax 88B, and also 0.2 g of Silcolapse® 426R and 0.18 g of Kathon® CG/ICP in 60.92 g of water together with 0.36 g of hexamethylenediamine. The mixture was dispersed with a disperser at 15 000 rpm for 10 minutes. The resulting reaction mixture is heated up to 70° C. within one hour and kept at 70° C. with gentle stirring for a further 4 hours. After subsequent cooling to room temperature, the mixture is thickened with 0.1 g of Rhodopol® G. In this way, a microcapsule formulation having a DCPMI content of 150 g/l and a particle size of 8.3 μm (d90) is obtained.

SC Formulations:

The ZC formulations of the invention were produced by producing the SC formulations that follow as mixing partner. These are blended with the formulations of the invention to give further formulations of the invention.

Production of the SC Formulations Based on the Safener

The production of SC formulations based on a safener (cloquintocet-mexyl or mefenpyr-diethyl) is effected analogously to BCS 15 3 070 by adding the safener in warm form as a melt to the formulation. The mixture is stirred for 2 to 24 h until crystals form. This is followed by wet grinding, for example by means of a bead mill. Finally, the organic thickener is added.

Production of an Aqueous Suspension Concentrate:

For production of the examples cited in table 1, water is initially charged at room temperature. The further components are then added (in no particular order) with stirring. This is followed by wet grinding, for example by means of a bead mill. Finally, the organic thickener is added.

TABLE 1
Formulations produced (FIGURES are in
percent by weight, % by weight)

| | SC-1 | SC-2 | SC-3 | SC-4 |
|---|---|---|---|---|
| mefenpyr- | 27.27 | | | |
| diethyl | | | | |
| cloquintocet- | | 27.27 | | |
| mexyl | | | | |
| flufenacet | | | | 42.37 |
| diflufenican | | | 42.37 | |
| Morwet ® D- | 1.0 | 1.0 | 1.0 | 1.0 |
| 425 | | | | |
| Pluronic ® PE | 5 | 5 | 5 | 5 |
| 10500 | | | | |
| citric acid | 0.1 | 0.1 | 0.1 | 0.1 |
| Aerosil ® 200 | 0.5 | 0.5 | 0.5 | 0.5 |
| Rhodopol ® 23 | 0.2 | 0.2 | 0.2 | 0.2 |
| Silcolapse ® 411 | 0.5 | 0.5 | 0.5 | 0.5 |
| glycerol | 5 | 5 | 5 | 5 |
| Proxel ® GXL | 0.18 | 0.18 | 0.18 | 0.18 |

| | | | | |
|---|---|---|---|---|
| Water is added to | | | | |
| give a total of 100% | | | | |
| Density of the | 1.1 | 1.1 | 1.19 | 1.19 |
| formulation | | | | |
| g/L active ingredient | 300 | 300 | 500 | 500 |
| content | | | | |

ZC Formulations Produced (Ready-Mix Formulations)

The respective formulations of the invention were mixed with further active ingredients. They were subsequently made up to 1 L with water.

| Example | 3 | 4 | 5 | Comp. 2 | Comp. 3 |
|---|---|---|---|---|---|
| Formulation type | ZC | ZC | ZC | ZC | ZC |
| Example 1 (CS | 0.6667 L | 0.6667 L | 0.6667 L | | |
| 150 g/L DCPMI and | | | | | |
| 75 g/L MPR) | | | | | |
| Comparative example | | | | 0.6667 L | 0.3333 L |
| 1 (CS 150 g/L | | | | | |
| DCPMI) | | | | | |
| SC-1 (MPR SC | | | | 0.3333 L | 0.1667 L |
| 300 g/L) | | | | | |
| SC-3 (DFF SC | | | 0.06 L | | |
| 500 g/L) | | | | | |
| SC-4 (FFA SC 500 | 0.15 L | 0.2 L | 0.12 L | | 0.075 L |
| g/L) | | | | | |
| Water to make up to | 0.1833 L | 0.1333 L | 0.1533 L | 0 | 0.425 L |
| 1 L | | | | | |
| Total loading in g/L | 225 | 250 | 240 | 150 | 137.5 |
| g/L DCPMI | 100 | 100 | 100 | 100 | 50 |
| g/L MPR | 50 | 50 | 50 | 50 | 50 |
| g/L DFF | | | 30 | 0 | |
| g/L FFA | 75 | 100 | 60 | 0 | 37.5 |
| Application rate for | 2 | 2 | 2 | 2 | 4 |
| field trials in L/ha | | | | | |
| g DCPMI active | 200 | 200 | 200 | 200 | 200 |
| ingredient per ha | | | | | |
| g safener MPR per ha | 100 | 100 | 100 | 100 | 100 |
| g DFF active | | | 60 | | |
| ingredient per ha | | | | | |
| g FFA active | 150 | 200 | 120 | | 150 |
| ingredient per ha | | | | | |
| Formulation stability | stable | stable | stable | stable | unstable |
| after 8W40° C. storage | | | | | |
| Relative volatility | 85% | 85% | 85% | 85% | 85% |
| after 72 h of DCPMI | | | | | |

Formulation from comparative example 3 shows agglomerates and crystal growth in the formulation. In the wet sieving of the product, 3% active ingredient was left behind on a150 μm screen.

Determination of the Relative Volatility of the Active Ingredient

A spray liquor (0.5 g of active ingredient/l) is placed onto each of three Teflon membranes in a glass box open at the top in a laboratory fume hood under a constant air flow of 1.6 m/s at 22° C. and 60% relative air humidity. The residue on the Teflon membranes is determined by HPLC after drying after 0 and 72 h. The volatility is based on the 0 h value. In other words, a value of 85% as relative volatility means that 85% of the active ingredient is nonvolatile and remains on the Teflon membrane.

The results in the above table show that the volatilization was not adversely affected by the safener in the capsule and hence the control of volatility of DCPMI is at a very high level.

Greenhouse Trials:

In the standard implementation of the test, seeds of various broad-leaved weed and weed grass biotypes (origins) were sown in an 8-13 cm diameter pot filled with natural soil of a standard field soil (loamy silt; non-sterile) and covered with a covering soil layer of about 1 cm. The pots were then cultivated in a greenhouse (light for 12-16 h, temperature 20-22° C. by day, 15-18° C. by night) until the time of application. The pots were treated on a laboratory track sprayer with spray liquors comprising the mixtures/compositions of the invention, mixtures of the prior art or the components applied individually. Application of the active ingredients or active ingredient combinations formulated as WG, WP, EC or otherwise was effected at the appropriate growth stages of the plants. The amount of water used for spray application was 100-6001/ha. After the treatment, the plants were returned to the greenhouses.

About 3 weeks after the application, the soil action or/and foliar action was assessed visually according to a scale of 0-100% in comparison to an untreated comparative group: 0%=no noticeable effect compared to the untreated comparative group; 100%=full effect compared to the untreated comparative group.

(Notes: the term “seeds” also includes vegetative propagation forms such as, for example, rhizome pieces; abbreviations used: h light=hours of illumination, g of AS/ha=grams of active substance per hectare, 1/ha=liters per hectare, S=sensitive, R=resistant)
1. Pre-emergence action against weeds: Seeds of various broad-leaved weed and weed grass biotypes (origins) were sown in an 8-13 cm diameter pot filled with natural soil of a standard field soil (loamy silt; non-sterile) and covered with a covering soil layer of about 1 cm. The pots were then cultivated in a greenhouse (light for 12-16 h, temperature 20-22° C. by day, 15-18° C. by night) until the time of application. The pots were treated at BBCH stage 00-10 of the seeds/plants on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required.
2. Post-emergence action against weeds: Seeds of various broad-leaved weed and weed grass biotypes (origins) were sown in an 8-13 cm diameter pot filled with natural soil of a standard field soil (loamy silt; non-sterile) and covered with a covering soil layer of about 1 cm. The pots were then cultivated in a greenhouse (light for 12-16 h, temperature 20-22° C. by day, 15-18° C. by night) until the time of application. The pots were treated at various BBCH stages between 11-25 of the seeds/plants, i.e. generally between two to three weeks after the start of the cultivation, on a laboratory track sprayer with spray liquors comprising the mixtures/compositions of the invention, mixtures or the components applied individually as WG, WP, EC or other formulations. The amount of water used for spray application was 100-6001/ha. After the treatment, the plants were returned to the greenhouses and fertilized and watered as required.
3. Pre-emergence action against weeds with and without active ingredient incorporation: Seeds of various broad-leaved weed and weed grass biotypes (origins) were sown in an 8-13 cm diameter pot filled with natural soil of a standard field soil (loamy silt; non-sterile). By way of comparison, the pots with the seeds were treated at BBCH stage 00-10 of the seeds/plants, i.e. generally two to three weeks after the start of the cultivation, on a laboratory track sprayer either with spray liquors comprising the mixtures/compositions of the invention, mixtures or the components applied individually as WG, WP, EC or other formulations, or an equivalent amount of the mixtures/compositions of the invention, mixtures or the components applied individually as WG, WP, EC or other formulations was incorporated into the 1 cm covering layer. The amount of water used for spray application was 100-6001/ha. After the treatment, the plants were returned to the greenhouses and fertilized and watered as required. The pots were cultivated in a greenhouse (light for 12-16 h, temperature 20-22° C. by day, 15-18° C. by night).
4. Selective pre-emergence action: Seeds of various crop species (origins) were sown in an 8-13 cm diameter pot filled with natural soil of a standard field soil (loamy silt; non-sterile) and covered with a covering soil layer of about 1 cm. The pots were then cultivated in a greenhouse (light for 12-16 h, temperature 20-22° C. by day, 15-18° C. by night) until the time of application. The pots were treated at BBCH stage 00-10 of the seeds/plants on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required.
5. Selective post-emergence action: Seeds of various crop species (origins) were sown in an 8-13 cm diameter pot filled with natural soil of a standard field soil (loamy silt; non-sterile) and covered with a covering soil layer of about 1 cm. The pots were then cultivated in a greenhouse (light for 12-16 h, temperature 20-22° C. by day, 15-18° C. by night) until the time of application. The pots were treated at various BBCH stages 11-32 of the seeds/plants, i.e. generally between two to four weeks after the start of the cultivation, on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required. The pots were cultivated in a greenhouse (light for 12-16 h, temperature 20-22° C. by day, 15-18° C. by night).
6. Effect on weeds in pre-sowing application: Seeds of various broad-leaved weed and weed grass biotypes (origins) were sown in an 8-13 cm diameter pot filled with natural soil of a standard field soil (loamy silt; non-sterile). The pots with the seeds were treated prior to sowing on a laboratory track sprayer with spray liquors comprising the mixtures/compositions of the invention, mixtures or the components applied individually as WG, WP, EC or other formulations. The amount of water used for spray application was 100-600 l/ha. After sowing, the pots were placed in the greenhouses and fertilized and watered as required. The pots were cultivated in a greenhouse (light for 12-16 h, temperature 20-22° C. by day, 15-18° C. by night).
7. Pre-emergence and post-emergence action against weeds under various cultivation conditions: Seeds of various broad-leaved weed and weed grass biotypes (origins) were sown in an 8-13 cm diameter pot filled with natural soil of a standard field soil (loamy silt; non-sterile) and covered with a covering soil layer of about 1 cm. The pots were then cultivated in a greenhouse (light for 12-16 h, temperature 20-22° C. by day, 15-18° C. by night) until the time of application. The pots were treated at various BBCH stages 00-25 of the seeds/plants on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required. The pots were cultivated in a greenhouse (light for 12-16 h, temperature 20-22° C. by day, 15-18° C. by night). Irrigation was varied according to the issue. Here, the individual comparative groups were provided with gradually differing amounts of water in a range from above the PWP (permanent wilting point) up to the level of maximum field capacity.
8. Pre-emergence and post-emergence action against weeds under various irrigation conditions: Seeds of various broad-leaved weed and weed grass biotypes (origins) were sown in an 8-13 cm diameter pot filled with natural soil of a standard field soil (loamy silt; non-sterile) and covered with a covering soil layer of about 1 cm. The pots were then cultivated in a greenhouse (light for 12-16 h, temperature 20-22° C. by day, 15-18° C. by night) until the time of application. The pots were treated at various BBCH stages 00-25 of the seeds/plants on a laboratory track sprayer with spray liquors comprising the mixtures/compositions of the invention, mixtures or the components applied individually as WG, WP, EC or other formulations. The amount of water used for spray application was 100-6001/ha. After the treatment, the plants were returned to the greenhouses and fertilized and watered as required. The pots were cultivated in a greenhouse (light for 12-16 h, temperature 20-22° C. by day, 15-18° C. by night). The individual comparative groups were subjected to different irrigation techniques. Irrigation was either from below or gradually from above (simulated rain).
9. Pre-emergence and post-emergence action against weeds under various soil conditions: Seeds of various broad-leaved weed and weed grass biotypes (origins) were sown in an 8-13 cm diameter pot filled with natural soil and covered with a covering soil layer of about 1 cm. To compare the herbicidal action, the plants were cultivated in various cultivation soils from sandy soil to heavy clay soil and various contents of organic substance. The pots were then cultivated in a greenhouse (light for 12-16 h, temperature 20-22° C. by day, 15-18° C. by night) until the time of application. The pots were treated at various BBCH stages 00-25 of the seeds/plants on a laboratory track sprayer with spray liquors comprising the mixtures/compositions of the invention, mixtures or the components applied individually as WG, WP, EC or other formulations. The amount of water used for spray application was 100-6001/ha. After the treatment, the plants were returned to the greenhouses and fertilized and watered as required. The pots were cultivated in a greenhouse (light for 12-16 h, temperature 20-22° C. by day, 15-18° C. by night).
10. Pre-emergence and post-emergence action against weeds for the control of resistant weed grass/broad-leaved weed species: Seeds of various broad-leaved weed and weed grass biotypes (origins) having various resistance mechanisms against different modes of action were sown in an 8 cm diameter pot filled with natural soil of a standard field soil (loamy silt, LSI; pH 7.4; % C org 2.2) and covered with a covering soil layer of about 1 cm. The pots were then cultivated in a greenhouse (12-16 h light, temperature day about 23° C., night about 15° C.) until the time of application. The pots were treated at various BBCH stages 00-25 of the seeds/plants on a laboratory track sprayer with spray liquors comprising the mixtures/compositions of the invention, mixtures or the components applied individually as WG, WP, EC or other formulations. The amount of water used for spray application was 300 l/ha. After the treatment, the plants were returned to the greenhouses and fertilized and watered as required. The pots were cultivated in a greenhouse (12-16 h light, temperature day about 23° C., night about 15° C.).
11. Pre-emergence and post-emergence action against weeds and crop selectivity under various sowing conditions: Seeds of various broad-leaved weed and weed grass biotypes (origins) and crop species (origins) were sown in an 8-13 cm diameter pot filled with natural soil and covered with a covering soil layer of about 0-5 cm. The pots were then cultivated in a greenhouse (light for 12-16 h, temperature 20-22° C. by day, 15-18° C. by night) until the time of application. The pots were treated at various BBCH stages 00-25 of the seeds/plants on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required. The pots were cultivated in a greenhouse (light for 12-16 h, temperature 20-22° C. by day, 15-18° C. by night).
12. Pre-emergence and post-emergence action against weeds at different pH values of the soil: Seeds of various broad-leaved weed and weed grass biotypes (origins) were sown in an 8-13 cm diameter pot filled with natural soil and covered with a covering soil layer of about 1 cm. For comparison of the herbicidal activity, the plants were cultivated in cultivation soils of a standard field soil (loamy silt; non-sterile) with different pH values of pH 7.4 and pH 8.4. Accordingly, the soil was mixed with lime to achieve the higher pH value. The pots were then cultivated in a greenhouse (light for 12-16 h, temperature 20-22° C. by day, 15-18° C. by night) until the time of application. The pots were treated at various BBCH stages 00-10 of the seeds/plants on a laboratory track sprayer with spray liquors comprising the mixtures/compositions of the invention, mixtures or the components applied individually as WG, WP, EC or other formulations. The amount of water used for spray application was 100-600 l/ha. After the treatment, the plants were returned to the greenhouses and fertilized and watered as required. The pots were cultivated in a greenhouse (light for 12-16 h, temperature 20-22° C. by day, 15-18° C. by night).

Results from the Greenhouse:

Formulation 1 (MPR safener in the capsule) and comparative formulation 1 (MPR safener outside the capsule) were compared with one another in each case. The typical field application rate is 200 g a.i./ha DCPMI and 100 g a.i./ha mefenpyr-diethyl. The application window was early pre-emergence (BBCH 11). In order to generate maximum damage, the application rate was increased up to a factor of 2 in the greenhouse.

| | | Damage | |
|---|---|---|---|
| | | to winter | Damage |
| Formulation | Application | wheat | to barley |
| used | rate | in % | in % |
| Comparison 1 | 100 g DCPMI | 0 | 0 |
| | and 50 g | | |
| | MPR/ha | | |
| Example 1 | 100 g DCPMI | 0 | 0 |
| | and 50 g | | |
| | MPR/ha | | |
| Comparison 1 | 200 g DCPMI | 0 | 0 |
| | and 100 g | | |
| | MPR/ha | | |
| Example 1 | 200 g DCPMI | 0 | 0 |
| | and 100 g | | |
| | MPR/ha | | |
| Comparison 1 | 400 g DCPMI | 0 | 0 |
| | and 200 g | | |
| | MPR/ha | | |
| Example 1 | 400 g DCPMI | 0 | 0 |
| | and 200 g | | |
| | MPR/ha | | |

The formulations of the invention with the active herbicidal ingredients show very high activity coupled with low damage. It was surprisingly not possible to determine any difference in the formulations even though the safener is present in a slow-release formulation (CS) in the inventive examples.

Outdoor Trials:

In outdoor trials under natural conditions with the field being prepared in a manner customary in practice and with natural or artificial infestation with harmful plants, the compositions of the invention, mixtures of the prior art or the individual components were applied before or after sowing of the crop plants or before or after emergence of the harmful plants, and visual scoring was carried out over a period of 4 weeks to 8 months after the treatment by comparison with untreated sections (plots). Damage to the crop plants and activity against harmful plants were recorded here in percent, as were the other effects of the respective trial question.

b) Results

The following abbreviations were used:

BBCH=the BBCH code provides information about the morphological development stage of a plant. Officially, the abbreviation denotes the Biologische Bundesanstalt, Bundessortenamt und Chemische Industrie [Federal Biological Institute for Agriculture and Forestry, Federal Office for Crop Plant Varieties and Chemical Industry]. The range of BBCH 00-10 denotes the germination stages of the seeds until surface penetration. The range of BBCH 11-25 denotes the leaf development stages until stocking (corresponding to the number of tillers or side-shoots).

PE=pre-emergence application on the soil; BBCH of the seeds/plants 00-10.

PO=post-emergence application on the green parts of the plants; BBCH of the plants 11-25.

HRAC=Herbicide Resistance Action Committee which classifies the approved active ingredients according to their mode of action (MoA).

HRAC group A=acetyl coenzyme A carboxylase inhibitors (MoA: ACCase).

HRAC group B=acetolactate synthase inhibitors (MoA: ALS).

AS=active substance (based on 100% of active ingredient; syn. a.i.).

Dosage g of AS/ha=application rate in grams of active substance per hectare.

For the designation of the respective blackgrass biotypes (botanic designation: Alopecurus myosuroides; EPPO code or former Bayer code: ALOMY), the EPPO code was used with an additional identifier:
ALOMY_DEU12053 denotes a biotype having elevated metabolic ALS resistance (EMR) without ALS target site resistance (TSR).
ALOMY_DEU12061 denotes a biotype having elevated metabolic ACCase resistance (EMR) without ACCase target site resistance (TSR).
ALOMY_R35 denotes a biotype sensitive to herbicides with ALS or ACCase mode of action (MoA).

The activities of the herbicidal compositions of the invention meet the stated demands and therefore achieve the object of improving the application profile of the herbicidally active ingredient 2-[(2,4-dichlorophenyl)methyl]-4,4-dimethyl-3-isoxazolidinone (including provision of more flexible solutions with regard to the application rates required for unchanged to enhanced activity).

Where the focus was on herbicidal effects of the compositions of the invention compared to prior art mixtures or compared to components applied individually against economically significant mono- and dicotyledonous harmful plants, the synergistic herbicidal activities were calculated using Colby's formula (cf. S. R. Colby; Weeds 15 (1967), 20-22):

Field Results for the Herbicidal Efficacy of the Aqueous Dispersions:

Method: Standard autumn field application of 2001/ha spray liquors at a dosage of 150 g of flufenacet, 200 g of DCPMI and 100 g of mefenpyr-diethyl per hectare. Herbicidal efficacy on blackgrass (Alopecurus myosuroides; ALOMY), phytotoxicity on the crop plants winter barley and winter wheat, and damage to a neighboring crop (tree plantation, sugarbeet, broccoli) were evaluated. On a scale of 0-100%, a visual assessment was made by comparison with an untreated comparative group: 0%=no noticeable effect compared to the untreated comparative group; 100%=full effect compared to the untreated comparative group.

TABLE
Field results-early post-emergence, BBCH 11

| | Herbicidal | |
|---|---|---|
| | activity with | Phytotoxicity |
| | respect to | on . . . |
| Example | ALOMY | winter wheat |
| Example 3 | good (80%) | low (5%) |
| Comparative | good (80%) | low (5%) |
| example 3 | | |

The assessment took place at the end of March (application at the end of September). The formulations of the invention show very high activity without causing more damage. It was not possible to find a difference in the formulations, even though the safener was released only slowly here too.

1. A capsule suspension concentrate comprising
A) a particulate disperse phase (capsule) comprising
a) a reaction product of at least one compound having isocyanate-reactive groups a1) and an isocyanate mixture a2),
b) optionally an active ingredient b)
s) a safener s), dissolved in an organic, water-insoluble solvent L),
c) optionally one or more additives and
B) d) a liquid aqueous phase,
wherein the particles of the disperse phase A) have a median particle size between 1 and 50 μm.

2. The capsule suspension concentrate as claimed in claim 1, wherein at least one active ingredient b) is present in the capsule.

3. The capsule suspension concentrate as claimed in claim 1, comprising at least one protective colloid c1).

4. The capsule suspension concentrate as claimed in claim 1, comprising at least one nonencapsulated active ingredient z).

5. The capsule suspension concentrate as claimed in claim 1, wherein the active ingredient b) is selected from the group comprising anilofos, acephate, benfluralin, bifenthrin, bupirimate, butralin, chloroacetic acid, cyfluthrin, cynmethylin, cypermethrin, demeton-S-methyl sulfone, dimethametryn, dimethoate, dioxabenzofos, diphenylamine, dithiopyr, dodemorph acetate, esfenvalerate, ethalfluralin, ethofumesate, fenazaquin, fenitropan, fenoxycarb, fenuron-TCA, fenvalerate, fluoroglycofen-ethyl, flupyradifuron, flurazole, flurochloridone, fluroxypyr-meptyl, flusilazole, furalaxyl, haloxyfop-etotyl, haloxyfop-methyl, imazalil, ioxynil octanoate, isoprothiolane, metalaxyl, methomyl, methoprotryne, monocrotophos, nitrapyrin, nitrothal-isopropyl, penconazole, pendimethalin, permethrin, propamocarb hydrochloride, propaquizafop, pyrazophos, quizalofop-P-tefuryl, resmethrin, trichloroacetic acid, tetramethrin, thiofanox, triflumizole, pyridaphenthion, 2-phenylphenol, dimethylvinphos, beta-cypermethrin, famphur, clodinafop-propargyl, triazamate, tebufenpyrad, pyrimidifen, aldrin, bromophos, dialifos, pyriminobac-methyl, benzoylprop, benzoylprop-ethyl, binapacryl, camphechlor, chlorfenethol, chlorfenprop, chlorfenprop-methyl, chlorphoxim, crufomate, cyometrinil, 1,1-dichloro-2,2-bis(4-ethylphenyl)ethane, dimetilan, dinobuton, fenson, fenthiaprop, fenthiaprop-ethyl, fluenetil, glyodin, 2-isovalerylindane-1,3-dione, methoxyphenone, 2-methoxyethylmercury chloride, nitrofen, indanofan, acequinocyl, ipsdienol with (S)-cis-verbenol, fenoxanil, pyraclostrobin, trifloxystrobin, cyflufenamid, gamma-cyhalothrin, proquinazid, 2,6-diisopropylnaphthalene, isotianil and 2-[(2,4-dichlorophenyl)methyl]-4,4′-dimethyl-3-isoxazolidinone (DCPMI).

6. The capsule suspension concentrate as claimed in claim 1, wherein the active ingredient b) is DCPMI.

7. The capsule suspension concentrate as claimed in claim 1, wherein the safener s) is selected from the group comprising isoxadifen-ethyl, cyprosulfamide, cloquintocet-mexyl and mefenpyr-diethyl.

8. A process for producing the capsule suspension concentrate as claimed in claim 1, wherein,
(1), a safener s) dissolved in an organic, water-insoluble solvent L) is mixed with the isocyanate mixture a2) and optionally with an organic solvent and/or emulsifier, the solution thus prepared is then,
(2), emulsified in water, optionally containing a protective colloid c1), optionally in a mixture with further additives d), and the emulsion E thus prepared,
(3), is admixed with one or more isocyanate-reactive groups a1) and then, optionally, further additives d) are added.

9. The process for producing the capsule suspension concentrate as claimed in claim 8, wherein, in 1, an active ingredient b) dissolved in an organic, water-insoluble solvent L) is further additionally added.

10. A ZC formulation comprising a capsule suspension concentrate as claimed in claim 1 and at least one suspension concentrate (SC) comprising
one or more active ingredients z),
at least one or more than one thickener c),
one or more anionic emulsifiers e1) and/or
one or more nonionic emulsifiers e2).

11. The ZC formulation as claimed in claim 10, comprising at least one further safener.

12. The ZC formulation as claimed in claim 10, wherein the active ingredient z) is selected from the group consisting of flufenacet, prosulfocarb, pendimethalin, diflufenican, aclonifen, metribuzin, pyroxasulfone, propoxycarbazone, thiencarbazone-methyl, fenoxaprop, bromoxynil, halauxifen-methyl, 2,4-D, MCPA.

13. A product comprising the capsule suspension concentrate as claimed in claim 1 as herbicide in one or more of cereals and/or oilseed rape, for use with a pre-emergence and/or post-emergence method.

14. A method of controlling one or more unwanted plants in one or more plant crops, comprising deploying the capsule suspension concentrate as claimed in claim 1 on the plants, or an area on which plants grow.
